(19) United States
(12) Patent Application Publication
(10) Pub. No.: US 2019/0058178 A1
(43) Pub. Date: Feb. 21, 2019

(54) POLYIMIDE-NETWORK AND POLYIMIDE-UREA-NETWORK BATTERY SEPARATOR COMPOSITIONS

(71) Applicants: Ohio Aerospace Institute, Brook Park, OH (US); U.S. Government, represented by the Administrator of the National Aeronautics & Space Administration, Washington, DC (US)

(72) Inventors: Mary Ann B. Meador, Strongsville, OH (US); Baochau N. Nguyen, North Royalton, OH (US); Rocco P. Viggiano, Elyria, OH (US)

(21) Appl. No.: 15/679,663

(22) Filed: Aug. 17, 2017

(51) Int. Cl. H01M 2/16; C08K 5/3445; C08G 73/10; C08J 9/28; H01M 10/0525

(52) U.S. Cl. CPC H01M 2/1653; C08K 5/3445; C08G 73/1092; C08J 9/286; C08J 2379/08; C08K 2201/001; C08G 2220/00; C08J 2205/024; H01M 10/0525

(57) ABSTRACT

Polyimide-network battery-separator compositions are disclosed. The polyimide-network battery-separator compositions comprise a porous cross-linked polyimide network comprising a polyamic acid oligomer. The polyamic acid oligomer (i) comprises a repeating unit of a dianhydride and a diamine and terminal functional groups, (ii) has an average degree of polymerization of 10 to 70, (iii) has been cross-linked via a cross-linking agent, comprising three or more cross-linking groups, at a balanced stoichiometry of the cross-linking groups to the terminal functional groups, and (iv) has been chemically imidized to yield the porous cross-linked polyimide network. The polyimide-network battery-separator compositions also comprise an electrolyte composition comprising (i) a room temperature ionic liquid and (ii) a lithium ion. The electrolyte composition is interfused within the porous cross-linked polyimide network. Polyim ide-urea-network battery-separator compositions also are disclosed. Voltaic cells comprising a cathode, an anode, and the polyimide-network battery separator composition or the polyimide-urea-network battery separator composition are also disclosed.

### STATEMENT OF GOVERNMENT-SPONSORED RESEARCH

This invention was made with government support under Contract No. NNC13BA01B awarded by NASA. The government has certain rights in this invention.

### FIELD OF THE INVENTION

The present invention relates generally to polyimide-network and polyimide-urea network battery-separator compositions, and more particularly, to polyimide-network and polyimide-urea network battery-separator compositions that comprise a porous cross-linked polyimide network or a porous cross-linked polyimide-urea network, respectively, and an electrolyte composition comprising a room temperature ionic liquid and a lithium ion.

### BACKGROUND OF THE INVENTION

Battery separators are crucial for safe and efficient operation of lithium-based batteries. A battery includes one or more voltaic cells. A voltaic cell includes a cathode, an anode, an electrolyte composition, and a battery separator. Lithium-based batteries, such as lithium-ion batteries and lithium-metal batteries, including lithium-air batteries and lithium-sulfur batteries, include a lithium ion or lithium metal in their cathode or anode, and a lithium ion in their electrolyte composition. Regarding safe operation of lithium-based batteries, the battery separator prevents the cathode and the anode from coming into contact with each other, which would cause a short circuit. Preventing contact between the cathode and the anode is particularly important with lithium-based batteries, because such contact, and the corresponding short circuit, can result in a dangerous increase in temperature of the battery, thermal instability, and “thermal runaway” involving venting of flaming gasses from the battery. Regarding efficient operation of lithium-based batteries, the battery separator also contains a liquid phase through which ions must be able to move in order to transport current through the electrolyte composition. The battery separator should serve this function while contributing minimally to the overall mass and volume of the voltaic cell, in order to maximize specific energy and energy density of the voltaic cell.

Ideally battery separators for lithium-based batteries should (i) provide mechanical and dimensional stability, including having sufficient mechanical strength to allow manufacture of the battery separator, and limiting formation of lithium dendrites within a voltaic cell over time, which may displace or pierce the battery separator, (ii) exhibit chemical resistance to degradation by electrolytes, (iii) exhibit uniform thickness, (iv) have a porosity of at least 40%, (v) serve as an electrical insulator, (vi) be readily wetted by electrolyte compositions, (vii) provide minimal resistance to electrolytes, (viii) possess a broad thermal-use regime, (ix) have a “shut-off” temperature, and (x) be non-flammable.

CELGARD battery separators are current standard battery separators used for lithium-based batteries. CELGARD battery separators are porous membranes corresponding to a single layer of polyethylene, a single layer of polypropylene, or a tri-layer of polypropylene, polyethylene, and polypropylene that have thicknesses ranging from 20 to 25 μm, porosities ranging from 40 to 43%, and melting temperatures of 135° C. for polyethylene layers and 165° C. for polypropylene layers. CELGARD battery separators are typically used with electrolyte compositions including ethylene carbonate or propylene carbonate, which are suitable for wetting the CELGARD battery separators, and a lithium ion. CELGARD battery separators used with these electrolyte compositions exhibit ionic conductivities ranging from 1×10⁻² S/cm to 1×10⁻³ S/cm. Considering CELGARD polyethylene battery separators and their use with lithium-ion batteries in particular, polyethylene has a low melting point, below the thermal runaway temperature of lithium-ion batteries. Thus, CELGARD battery separators including polyethylene offer a safety feature by closing ionic conduction pathways before their corresponding lithium-ion batteries can become thermally unstable. Nonetheless, CELGARD battery separators still have limitations regarding safe and efficient use. For example, although the low melting point of the polyethylene is useful for preventing thermal runaway, the low melting point also limits the thermal-use regime. Moreover, polyethylene, ethylene carbonate, and propylene carbonate are all highly flammable and thus are still subject to burning, independent of thermal runaway, upon exposure to flame.

Polymers more robust than polyethylene have been proposed as promising materials for development of lithium-ion battery separators with enhanced safety properties. For example, Xiang et al, ChemSusChem, vol. 9, pages 3023-3039 (2016), discloses that polyim ides, which have high mechanical strength, good thermal resistance, and chemical stability, have been used to prepare high-performance separators for lithium-ion batteries, based on electrospun polyimide. Xiang discloses, though, that a particular polyimide-PVDF-HFP core-shell nanofiber separator was then developed to improve wettability of the polyimide-based separator, suggesting that wettability of the polyimide-based separator itself was deficient.

Block copolymers also have been proposed as promising materials for development of lithium-ion battery separators. For example, Meador et al., U.S. Pat. No. 8,841,406, discloses synthesis of polyimide-poly(ethylene oxide) block co-polymers for use both as solid polymer electrolytes and as battery separators swollen with room temperature ionic liquids. These polyimide-poly(ethylene oxide) block co-polymers were synthesized to be non-porous solids. The non-porous solids of polyimide-poly(ethylene oxide) block co-polymers exhibited ionic conductivities of 1×10⁻⁵ S/cm at 25° C. Once room temperature ionic liquids had been added to the polyimide-poly(ethylene oxide) block co-polymers, ionic conductivities as high as 1×10⁻² S/cm at 25° C. were reached. The polyimide-poly(ethylene oxide) block co-polymers exhibit a lack of mechanical strength, though. Once the room temperature ionic liquid was added to the polyimide-poly(ethylene oxide) block co-polymers, the mechanical properties of the block co-polymers were diminished.

Accordingly, a need exists for improved battery-separator compositions and methods of making such compositions. A need also exists for improved lithium-based voltaic cells comprising the improved battery-separator compositions.

### BRIEF SUMMARY OF THE INVENTION

A polyimide-network battery-separator composition is provided. The polyimide-network battery-separator composition comprises (a) a porous cross-linked polyimide network. The porous cross-linked polyimide network comprises a polyamic acid oligomer, wherein the polyamic acid oligomer (i) comprises a repeating unit of a dianhydride and a diamine and terminal functional groups, (ii) has an average degree of polymerization of 10 to 70, (iii) has been cross-linked via a cross-linking agent, comprising three or more cross-linking groups, at a balanced stoichiometry of the cross-linking groups to the terminal functional groups, and (iv) has been chemically imidized to yield the porous cross-linked polyimide network. The polyimide-network battery-separator composition also comprises (b) an electrolyte composition. The electrolyte composition comprises (i) a room temperature ionic liquid and (ii) a lithium ion. The electrolyte composition is interfused within the porous cross-linked polyimide network.

A lithium-based voltaic cell also is provided. The lithium-based voltaic cell comprises a cathode, an anode, and the polyimide-network battery separator composition.

A polyimide-urea-network battery-separator composition also is provided. The polyimide-urea-network battery-separator composition comprises (a) a porous cross-linked polyimide-urea network. The porous cross-linked polyimide-urea network comprises a subunit comprising two polyamic acid oligomers in direct connection via a urea linkage, wherein: (i) the polyamic acid oligomers (a) each comprise a repeating unit of a dianhydride and a diamine and a terminal functional group and (b) are formulated with 2 to 20 of the repeating units; (ii) the subunit was formed by reaction of the diamine and a diisocyanate to form a diamine-urea linkage-diamine group, followed by reaction of the diamine-urea linkage-diamine group with the dianhydride and the diamine to form the subunit; (iii) the subunit has been cross-linked via a cross-linking agent, comprising three or more cross-linking groups, at a balanced stoichiometry of the cross-linking groups to the terminal functional groups; and (iv) the subunit has been chemically imidized to yield the porous cross-linked polyimide-urea network. The polyimide-urea-network battery-separator composition also comprises (b) an electrolyte composition. The electrolyte composition comprises (i) a room temperature ionic liquid and (ii) a lithium ion. The electrolyte composition is interfused within the porous cross-linked polyimide network.

Another lithium-based voltaic cell also is provided. The other lithium-based voltaic cell comprises a cathode, an anode, and the polyim ide-urea-network battery separator composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows chemical structures of various exemplary precursors and catalysts.

FIG. 2 shows chemical structures of exemplary dianhydrides.

FIG. 3 shows chemical structures of exemplary diamines.

FIG. 4 provides details of a polyimide network comprising BPDA, ODA, and N3300A, including (A) a scanning electron micrograph and (B) a scheme of a synthetic route for the polyimide network via chemical imidization, wherein n is the number of repeating units in polyamic acid oligomer comprising BPDA and ODA.

FIG. 5 shows a chemical structure of IPDI trimer.

FIG. 6 is a scheme of a synthetic route for a polyimide network comprising BPDA, BAX, and OAPS via chemical imidization, wherein n is the number of repeating units in polyamic acid oligomer comprising BPDA and BAX.

FIG. 7 is a scheme of a general synthetic route for a polyimide network cross-linked with TAB.

FIG. 8 is a scheme of a synthetic route for a polyimide network comprising BPDA, ODA or DMBZ, and 1,3,5-benzenetricarbonyl trichloride via chemical imidization.

FIG. 9 shows general chemical structures of various room temperature ionic liquids.

FIG. 10 shows specific chemical structures of various room temperature ionic liquids.

FIG. 11 is a scheme of a synthetic route for a polyimide-urea network comprising BTDA, BAPP, MDI, and TAB via chemical imidization, wherein n is the number of repeating units in polyamic acid oligomer comprising BTDA and BAPP.

FIG. 12 is a scheme of general reaction of isocyanate with (a) water, (b) aromatic diamine, and (c) side product(s). In accordance with Scheme 7, R and R′ can be, independently, for example, a phenyl ring.

FIG. 13 provides a comparison of a CELGARD battery separator (A, C) and a polyimide-network battery-separator composition (B, D), including photographs (A, B) and scanning electron micrographs (C, D).

FIG. 14 provides physical characteristics of a polyimide network corresponding to ODA-BPDA-N3300A, including (A) pore volume (cm³/g) per pore diameter (nm), (B) weight loss (%) per temperature (° C.), and (C) C-13 NMR spectrum.

FIG. 15 shows a graph of ionic conductivity (S/cm) versus porosity (%) of polyimide networks for polyimide-network battery-separator compositions for various room temperature ionic liquids as follows: 1-methyl-1-propylpyrrolidinium bis(trifluoromethylsulfonyl)imide (also designated “RTIL 1” herein) having a viscosity of 58.7 cP (squares), 1-butyl-1-methylpyrrolidinium bis(trifluoromethylsulfonyl)imide (also designated “RTIL 2” herein) having a viscosity of 72.1 cP (circles), and 1-ethyl-3-methylimidazolium bis(trifluoromethylsulfonyl)imide (also designated “RTIL 3” herein) having a viscosity of 39.4 cP (triangles).

FIG. 16 demonstrates stability of the room temperature ionic liquid 1-ethyl-3-methylimidazolium bis(trifluoromethylsulfonyl)imide in the presence of an aluminum cathode and a copper anode, with stability demonstrated based on an absence of visible discoloration or reaction.

FIG. 17 shows a graph of current (red) and voltage (blue) versus time (seconds) for a polyimide-network battery-separator composition including the room temperature ionic liquid 1-ethyl-3-methylimidazolium bis(trifluoromethylsulfonyl)imide that was cycled for 14 hours with an aluminum cathode and a copper anode.

### DETAILED DESCRIPTION OF THE INVENTION

Described herein are polyimide-network battery-separator compositions, polyimide-urea-network battery-separator compositions, and lithium-based voltaic cells comprising the polyimide-network battery-separator compositions or polyimide-urea-network battery-separator compositions. The polyimide-network battery-separator compositions comprise a porous cross-linked polyimide network and an electrolyte composition comprising a room temperature ionic liquid and a lithium ion, wherein the electrolyte composition is interfused within the porous cross-linked polyimide network. Similarly, the polyimide-urea-network battery-separator compositions comprise a porous cross-linked polyimide-urea network and an electrolyte composition comprising a room temperature ionic liquid and a lithium ion, also wherein the electrolyte composition is interfused within the porous cross-linked polyimide-urea network.

Surprisingly, it has been determined that the polyimide-network battery-separator compositions can be made having ionic conductivities, across the porous cross-linked polyimide networks, of 1.0×10⁻⁴ to 8.0×10⁻³ S/cm at 25° C., while also exhibiting wide thermal use windows and being non-flammable, based on the polyimide-network battery-separator compositions being in the form of films and having film thicknesses of 0.0050 to 0.1000 cm, the corresponding electrolyte compositions comprising room temperature ionic liquids, and the corresponding porous cross-linked polyimide networks having porosities of 80 to 95%. These characteristics make the compositions structurally and functionally suitable for use as battery separators in lithium-based voltaic cells, and offer the possibility of safer and more efficient operation of lithium-based batteries relative to current standard battery separators. The same applies regarding the polyimide-urea-network battery-separator compositions.

Without wishing to be bound by theory, it is believed that the polyimide-network battery-separator compositions and the polyimide-urea-network battery-separator compositions exhibit and maintain robust properties like those of polyimides generally, including high mechanical strength, good thermal resistance, and chemical stability, under conditions relevant to operation of lithium-based voltaic cells, allowing safer operation. The high mechanical strength, good thermal resistance, and chemical stability should enable the corresponding porous cross-linked polyimide and polyimide-urea networks to serve as effective mechanical barriers to prevent contact between a cathode and an anode of a lithium-based voltaic cell. The porous cross-linked polyimide and polyimide-urea networks can be cast into various three-dimensional shapes, as well as films. The porous cross-linked polyimide and polyimide-urea networks maintain their size and shape well within their wide thermal use windows, based on relatively high onsets of decomposition, e.g. about 500° C., decreasing the risk of mechanical failure due to decomposition, and are expected to limit lithium dendrite formation. The porous cross-linked polyimide and polyimide-urea networks can be tuned with respect to flexibility, making them suitable for use in standard lithium-based battery-separator formats including flat-compressed formats and tightly-wound formats. The porous cross-linked polyimide and polyimide-urea networks also can be tuned with respect to hydrophobicity and wettability, making them suitable for use with electrolyte compositions comprising room temperature ionic liquids. The porous cross-linked polyimide and polyimide-urea networks also can be tuned to shrink to varying extents at temperatures intended to serve as shut-off temperatures below their decomposition temperatures, potentially providing a functionality analogous to melting of polyethylene that may be useful for preventing thermal runaway, but with the advantage that the porous cross-linked polyimide and polyimide-urea networks, interfused with the room temperature ionic liquid, char instead of burning under direct exposure to flame.

Moreover, it is believed that the high mechanical strength, good thermal resistance, and chemical stability of the polyimide-network battery-separator compositions and the polyimide-urea-network battery-separator compositions also allows more efficient operation. The porous cross-linked polyimide and polyimide-urea networks are particularly amenable to interfusion with the electrolyte composition following synthesis, while in the form of wet gels. The solvents used in synthesis and/or storage of the wet gels can be exchanged efficiently with room temperature ionic liquids in the porous cross-linked polyimide and polyimide-urea networks, in contrast to deficient wettability of the previous polyimide-based separator as discussed above, resulting in correspondingly efficient ionic transport of current during use. Also, based on having porosities of 80 to 95%, the cross-linked polyimide and polyimide-urea networks may potentially contribute less than current standard battery separators to the overall mass and volume of the voltaic cell, so that the voltaic cell may have a higher specific energy and a higher energy density, for improved efficiency in generation of current.

Polyimide-Network Battery-Separator Compositions

A polyimide-network battery-separator composition is provided. The polyimide-network battery-separator composition comprises (a) a porous cross-linked polyimide network. The porous cross-linked polyimide network comprises a polyamic acid oligomer. The polyamic acid oligomer (i) comprises a repeating unit of a dianhydride and a diamine and terminal functional groups, (ii) has an average degree of polymerization of 10 to 70, (iii) has been cross-linked via a cross-linking agent, comprising three or more cross-linking groups, at a balanced stoichiometry of the cross-linking groups to the terminal functional groups, and (iv) has been chemically imidized to yield the porous cross-linked polyimide network. The polyimide-network battery-separator composition also comprises (b) an electrolyte composition. The electrolyte composition comprises (i) a room temperature ionic liquid and (ii) a lithium ion. The electrolyte composition is interfused within the porous cross-linked polyimide network.

Considering the porous cross-linked polyimide network in more detail, as noted the porous cross-linked polyimide network comprises a polyamic acid oligomer, and the polyamic acid oligomer comprises a repeating unit of a dianhydride and a diamine.

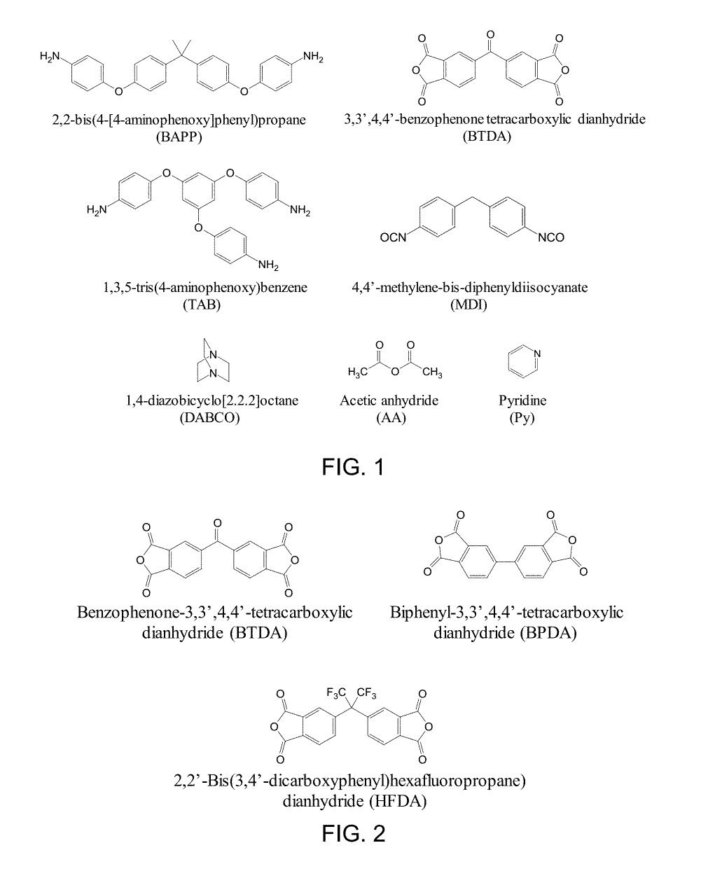

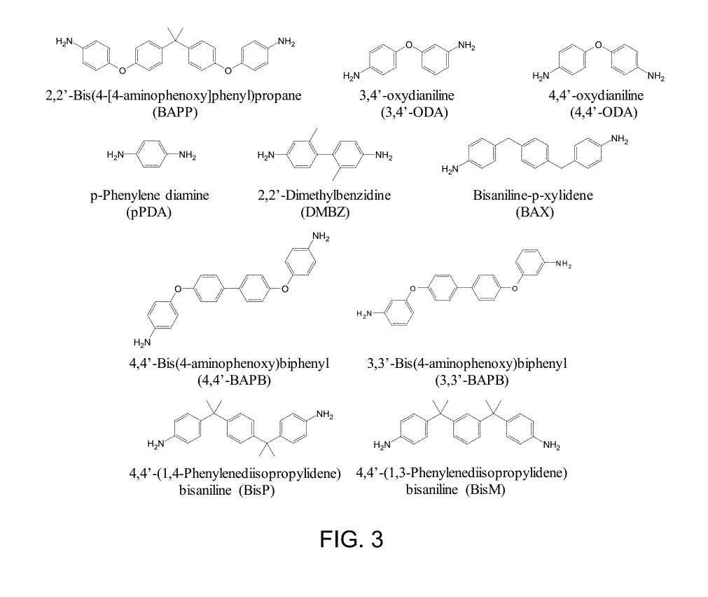

A variety of dianhydrides and diamines can be used, as shown in FIG. 1, FIG. 2, and FIG. 3. For example, the dianhydride can comprise one or more of biphenyl-3,3′,4,4′-tetracarboxylic dianhydride (“BPDA”), benzophenone-3,3′,4,4′-tetracarboxylic dianhydride (“BTDA”), pyromellitic dianhydride, or 2,2′-bis(3,4′-dicarboxyphenyl)hexafluoropropane dianhydride, as shown in FIG. 2. Also for example, the diamine can comprise one or more of 2,2′-dimethylbenzidine (“DMBZ”), 2,2′-bis[4-(4-am inophenoxy)phenyl]propane, 4,4′-oxydianiline (“4,4′-ODA” or “ODA”), 3,4′-oxydianiline (“3,4-ODA”), p-phenylene diamine (“PPDA”), bisaniline-p-xylidene (“BAX”), 4,4′-bis(4-aminophenoxy)biphenyl, 3,3′-bis(4-am inophenoxy)biphenyl, 4,4′-(1,4-phenylenediisopropylidene)bisaniline, 4,4′-(1,3-phenylenediisopropylidene)bisaniline, or O,O′-bis(2-aminopropyl) polypropylene glycol-block-polyethylene glycol-block-polypropylene glycol (“ED600”). as shown in FIG. 3. Additional suitable diamines include m-phenylenediamine, 4,4′-bis(aminophenoxy)-2,2′-dimethylbiphenyl (“BAPD”), 4,4′-[1,3-phenylenebis(1-methyl-ethylidene)]bisaniline (bisaniline-M), and 2,2-bis[4-(4-am inophenoxy)phenyl]hexafluoropropane (“HFBAPP”).

The dianhydride and/or diamine can be selected based on being known to impart different properties to polyim ides in general, and to cross-linked polyimide networks in particular, for example in order to tune cross-linked polyimide networks with respect to flexibility, hydrophobicity and wettability, and/or to shrink to varying extents at temperatures intended to serve as shut-off temperatures. For example, BPDA, PPDA, and DMBZ are known to produce a rigid backbone in polyimide structures, whereas ODA and BTDA have flexible linking groups between phenyl rings resulting in less rigid structures, although, as discussed in Meador et al., U.S. Pat. No. 9,109,088, cross-linked polyimide networks can exhibit properties distinct from those of other polyimide structures in this regard. Also for example the dianhydride and/or diamine can be selected based on their hydrophobicity and contribution to wettability in order to make a corresponding cross-linked polyimide network wettable by particular room temperature ionic liquids. Also for example, various polyimide aerogels exhibit shrinkage when heated at about 150° C. or higher, well below their decomposition temperatures, with the extent of shrinkage depending on the diamine, e.g. with greatest shrinkage observed for DMBZ, and least shrinkage observed for 50% DMBZ/50% ODA, as reported by Meador et al., ACS Appl. Mater. Interfaces, vol. 7, pp. 1240-1249 (2015). Also, shrinkage can be reduced when a bulky moiety is incorporated into the polyimide network, as reported by Viggiano et al., ACS Appl. Mater. Interfaces, vol. 9, pp. 8287-8296 (2017). Tuning shrinkage may provide a basis to achieve specific desired shut-off temperatures.

Two or more dianhydrides and/or two or more diamines can also be used in combination, as discussed with respect to diamines in particular in examples below. For example, a diamine known to produce a rigid backbone in polyimide structures, such as PPDA or DMBZ, can be used in combination with a diamine having flexible linking groups between phenyl rings, such as ODA, to tailor properties of the resulting porous cross-linked polyimide network. Thus, for example, the diamine can comprise (i) ODA and (ii) PPDA or DMBZ. In accordance with this example, PPDA and ODA can be used in combination, such that the mole percent of PPDA can be varied from 0% to 100% of the total diamine, e.g. from 20% to 80%, 30% to 70%, 40% to 60%, or at about 50%, with the remaining diamine corresponding to ODA, e.g. from 80% to 20%, 70% to 30%, 60% to 40%, or at about 50%. Also in accordance with this example, DMBZ and ODA can be used in combination, such that the mole percent of DMBZ can be varied from 0% to 100% of the total diamine, e.g. from 20% to 80%, 30% to 70%, 40% to 60%, or at about 50%, with the remaining diamine corresponding to ODA, e.g. from 80% to 20%, 70% to 30%, 60% to 40%, or at about 50%.

As noted, the polyamic acid oligomer also comprises terminal functional groups. A variety of terminal functional groups can be used. For example, the terminal functional groups can comprise (i) terminal anhydride groups, such that the polyamic acid oligomer comprises an anhydride end-capped polyamic acid oligomer, (ii) terminal amine groups, such that the polyamic acid oligomer comprises an amine end-capped polyamic acid oligomer, or (iii) terminal anhydride groups and terminal amine groups. Accordingly, in some examples the terminal functional groups comprise terminal anhydride groups. In accordance with these examples, the polyamic acid oligomer comprises an anhydride end-capped polyamic acid oligomer, i.e. both ends of the polyamic acid oligomer comprise a terminal anhydride group. Also in some examples the terminal functional groups comprise terminal amine groups. In accordance with these examples, the polyamic acid oligomer comprises an amine end-capped polyamic acid oligomer, i.e. both ends of the polyamic acid oligomer comprise a terminal amine group. Also in some examples, the terminal functional groups comprise terminal anhydride groups and terminal amine groups, i.e. some of the terminal functional groups are terminal anhydride groups, and others of the terminal functional groups are terminal amine groups.

As noted, the polyamic acid oligomer has an average degree of polymerization of 10 to 70. For example, the average degree of polymerization can be 15 to 45, or 20 to 35.

As noted, the polyamic acid oligomer has been cross-linked via a cross-linking agent. By this it is meant that molecules of polyamic acid oligomer have been cross-linked to each other via the cross-linking agent.

As noted, the cross-linking agent comprises three or more cross-linking groups. For example, the three or more cross-linking groups can comprise one or more of isocyanate groups, amine groups, or acid chloride groups. Accordingly, in some examples the three or more cross-linking groups comprise isocyanate groups. In accordance with these examples, the cross-linking agent can comprise, for example, one or more of a triisocyanate, trifunctional aliphatic isocyanate N3300A, or aliphatic polyisocyanate Desmodur Z4470 (also termed “IPDI trimer”). Also in some examples the three or more cross-linking groups comprise amine groups. In accordance with these examples, the cross-linking agent can comprise, for example, one or more of a triamine, an aliphatic amine comprising three or more amines, an aliphatic triamine, an aromatic amine comprising three or more amine groups, an aromatic triamine, 1,3,5-tri(am inophenoxy)benzene, a silica cage structure decorated with three or more amines, octa(aminophenyl)silsesquioxane, octa(aminophenyl)silsesquioxane as a mixture of isomers having the ratio meta:ortho:para of 60:30:10, or para-octa(aminophenyl)silsesquioxane. Also is some examples the three or more cross-linking groups comprise acid chloride groups. In accordance with these examples, the cross-linking agent can comprise, for example, one or more of a triacid chloride or 1,3,5-benzenetricarbonyl trichloride.

Like the dianhydride and/or diamine, the cross-linking agent can be selected based on being known to impart different properties to cross-linked polyimide networks, for example in order to tune cross-linked polyimide networks with respect to flexibility, hydrophobicity and wettability, and/or to shrink to varying extents at temperatures intended to serve as shut-off temperatures.

As noted, the cross-linking is carried out at a balanced stoichiometry of the cross-linking groups of the cross-linking agent to the terminal functional group of the polyamic acid oligomer. For example, for a cross-linking agent comprising three amine groups, such as 1,3,5-tri(aminophenoxy)benzene, the molar ratio of the cross-linking agent to the oligomer would be 2:3. Also for example, for a cross-linking agent comprising eight amine groups, such as octa(aminophenyl)silsesquioxane, the molar ratio of the cross-linking agent to the oligomer would be 1:4. As one of ordinary skill in the art will appreciate, carrying out the cross-linking at a balanced stoichiometry provides a cross-linked gel. This is in contrast to an imbalanced stoichiometry, which provides comb polymers that probably would not gel. Accordingly, as one of ordinary skill will also appreciate, a balanced stoichiometry need not be precisely balanced with respect to the molar ratio, but rather can tolerate some variation, e.g. plus or minus 10%, so long as the cross-linking provides a cross-linked gel.

As noted, the polyamic acid oligomer has been chemically imidized to yield the porous cross-linked polyimide network. The chemical imidization can be carried out, for example, by use of an imidization catalyst. The imidization catalyst can comprise, for example, one or more of 1,4-diazabicyclo[2.2.2]-octane (“DABCO”), triethylamine, acetic anhydride, and pyridine, as shown in FIG. 1. The polyamic acid oligomer can be chemically imidized to completion, e.g. all of the amic acid groups of each repeating unit of the polyamic acid oligomer can have reacted, e.g. intra-molecularly, to yield imide units. The polyamic acid oligomer can also be chemically imidized without using thermal imidization, e.g. without using an increase in temperature during imidization in order to increase the rate of imidization. The polyamic acid oligomer can be chemically imidized in a homogenous solution of imidization catalyst and polyamic acid oligomer, e.g. based on mixing of the imidization catalyst into a solution including the polyamic acid oligomer and the cross-linking agent before phase separation occurs in the solution, i.e. before cross-linking of the polyamic acid oligomer occurs to a sufficient extent such that a gel of the cross-linked polyamic acid oligomer separates from the solution phase.

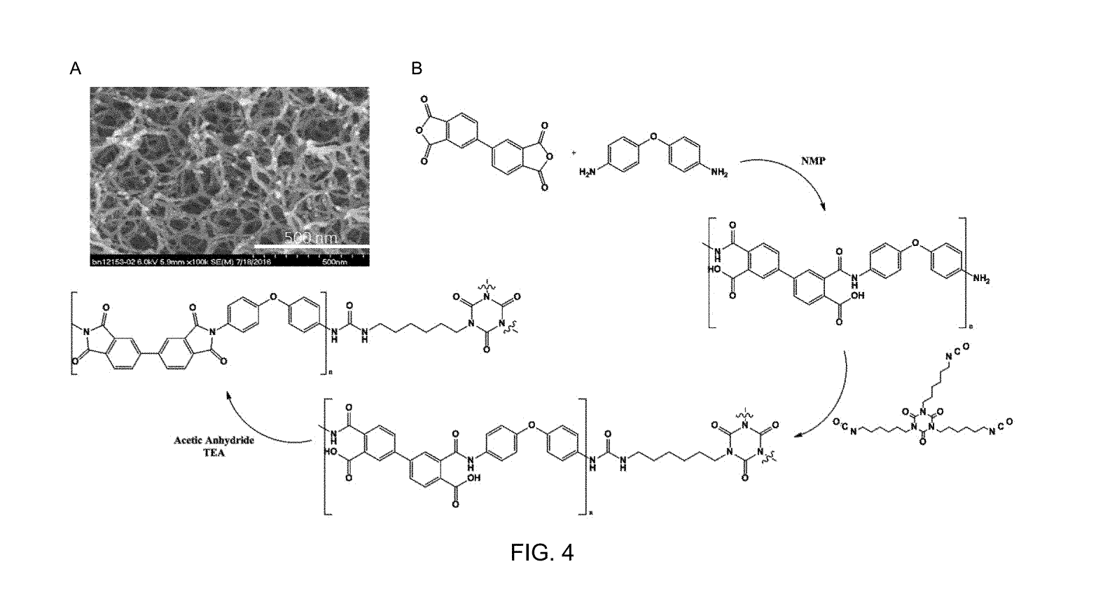

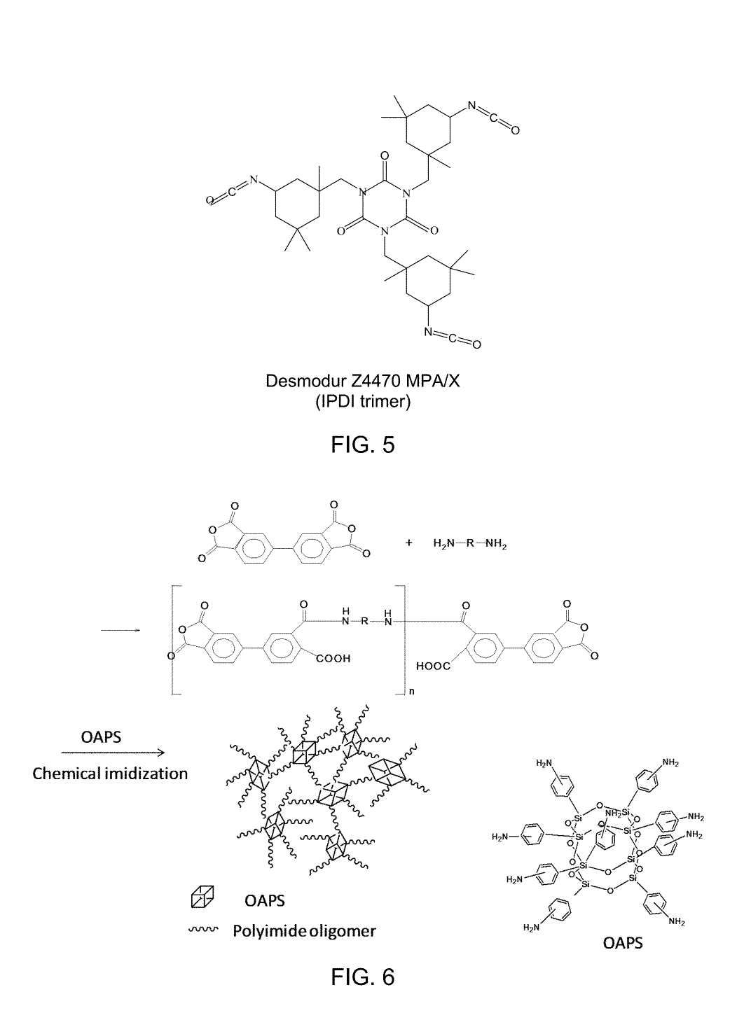

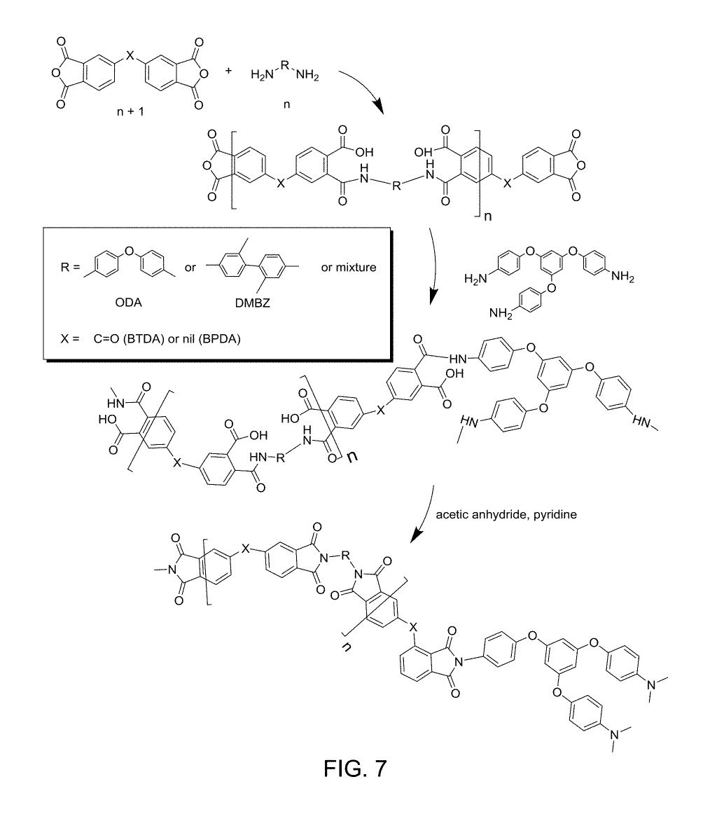

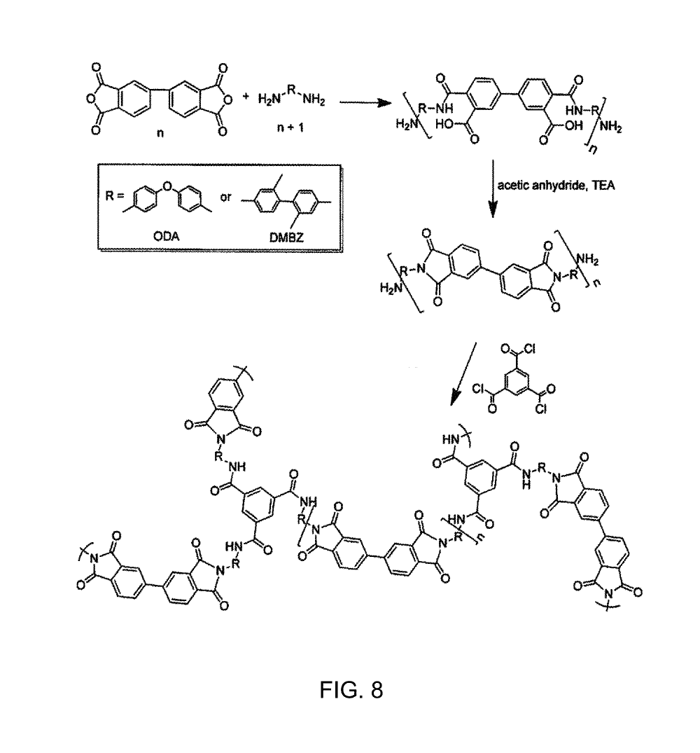

Schemes for synthetic routes of various exemplary porous cross-linked polyimide networks are provided in FIG. 4, FIG. 5, FIG. 6, FIG. 7, and FIG. 8. Specifically, FIG. 4 provides details of a polyimide network made from BPDA and ODA, and cross-linked with N3300A. FIG. 5 shows the cross-linking agent IPDI trimer. FIG. 6 provides details of a polyimide network made from BPDA and BAX, and cross-linked with OAPS. FIG. 7 provides details of a polyimide network made generally from dianhydride and diamine, and cross-linked with TAB. FIG. 8 provides details of a polyamide network made from BPDA and ODA or DMBZ, and cross-linked with 1,3,5-benzenetricarbonyl trichloride.

The porous cross-linked polyimide network can be synthesized as described, for example, in Meador et al., U.S. Pat. No. 9,109,088, which describes use of terminal functional groups comprising terminal anhydride groups and cross-linking agents comprising amine groups. The porous cross-linked polyimide network also can be synthesized as described, for example, in Meador et al., U.S. Pat. No. 9,434,832, which describes use of terminal functional groups comprising terminal amine groups and cross-linking agents comprising acid chloride groups.

An outline summary of a method for making the porous cross-linked polyimide network, followed by solvent exchange with the electrolyte composition, is as follows:

1. Dissolve monomers in solution.

2. Polyamic acid intermediate forms.

3. Chemical imidization at room temperature.

4. Cast gel into thin film.

5. Solvent exchange with desired electrolyte composition.

An exemplary method for making the porous cross-linked polyimide network is as follows. The method comprises polymerizing a dianhydride and a diamine in a solution to form an anhydride end-capped polyamic acid oligomer comprising terminal anhydrides and having an average degree of polymerization of 10 to 70, as discussed above.

The method also comprises cross-linking the polyamic acid oligomer with a cross-linking agent, comprising three or more amine groups, at a balanced stoichiometry of the amine groups to the terminal anhydride groups, as discussed above.

The method also comprises mixing an imidization catalyst into the solution, before phase separation occurs in the solution, to chemically imidize the cross-linked polyamic acid oligomer to form the network. Again, the imidization catalyst can be selected from the group consisting of 1,4-diazabicyclo[2.2.2]-octane, triethylamine, and pyridine. The polyamic acid oligomer can be chemically imidized to completion. The polyamic acid oligomer can be chemically imidized without using thermal imidization. The mixing of the imidization catalyst into the solution can result in a homogeneous distribution of the imidization catalyst in the solution. As noted, the mixing of the imidization catalyst into the solution is carried out before phase separation occurs in the solution. A water-scavenging agent, e.g. acetic anhydride, also can be mixed into the solution to scavenge water by-product of condensation.

The sum of the concentrations of the dianhydride, the diamine, and the cross-linking agent dissolved into the solution can be 5 to 20 w/w % of the solution, e.g. 7.5 to 15 w/w %, or 9 to 11 w/w %. The solution can comprise a solvent selected from the group consisting of N-methyl-2-pyrrolidinone (“NMP”), dimethylformamide (“DMF”), and dimethylacetamide (“DMAc”).

The porous cross-linked polyimide network can be synthesized as a wet gel comprising the porous cross-linked polyimide network. Along with the polyimide network, the wet gel can comprise a solvent that was used for preparation of the polyimide network. As noted, solvents that can be used for preparation of the polyimide network include, for example, NMP, DMF, and DMAc.

Turning to the electrolyte composition, as noted the electrolyte composition comprises a room temperature ionic liquid. The term “room temperature ionic liquid” as used herein means a salt that is liquid at room temperature, e.g. at 20° C., due to ions of the room temperature ionic liquid being poorly coordinated. In accordance with this meaning, a compound is classified as a room temperature ionic liquid based on this property, independent of the actual temperature of the compound at any given time. Accordingly, a room temperature ionic liquid remains a room temperature ionic liquid when its temperatures increases above room temperature, and also remains a room temperature ionic liquid when its temperature decreases below room temperature.

Room temperature ionic liquids generally include an asymmetric organic cation and a bulky anion with delocalized charge. Room temperature ionic liquids generally are nonvolatile and nonflammable. Ionic conductivity (a) of room temperature ionic liquids is inversely proportional to viscosity (n) of the room temperature ionic liquids.

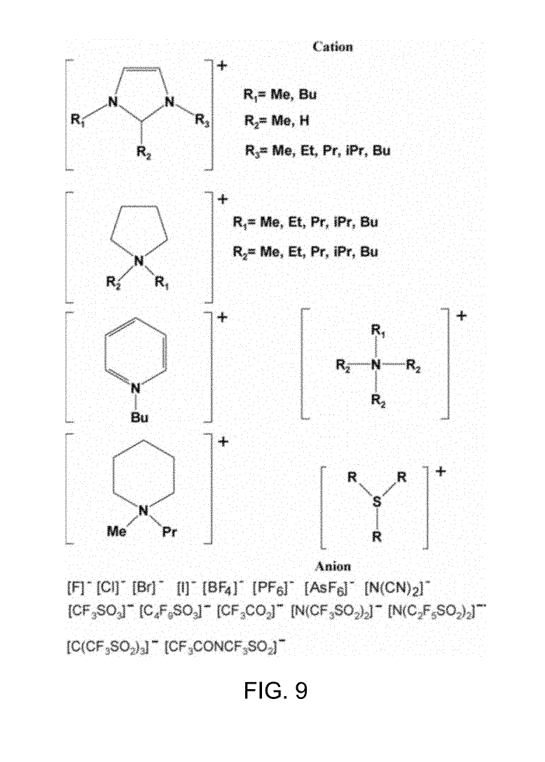

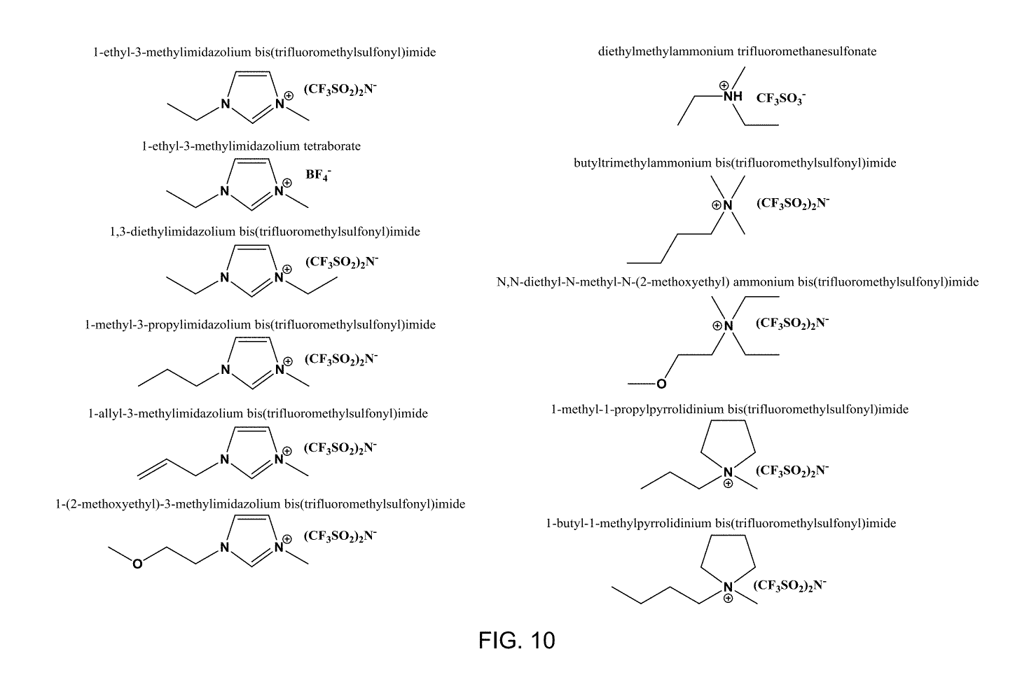

A variety of room temperature ionic liquids can be used, as shown in FIG. 9 and FIG. 10. For example, the room temperature ionic liquid can comprise one or more of 1-methyl-1-propylpyrrolidinium bis(trifluoromethylsulfonayl)imide, 1-butyl-1-methylpyrrolidinium bis(trifluoromethylsulfonayl)imide, 1-ethyl-3-methylimidazolium bis(trifluoromethylsulfonyl)imide, 1-ethyl-3-methylimidazolium triflate, 1-ethyl-3-methylimidazolium tetraborate, 1,3-diethylimidazolium bis(trifluoromethylsulfonyl)imide, 1-methyl-3-propylimidazolium bis(trifluoromethylsulfonyl)imide, butyltrimethylammonium bis(trifluoromethylsulfonayl)imide, 1-(2-methoxyethyl)-3-methylimidazolium bis(trifluoromethylsulfonyl)imide, diethylmethylammonium trifluoromethanesulfonate, 1-allyl-3-methylimidazolium bis(trifluoromethylsulfonyl)imide, or N,N-diethyl-N-methyl-N-(2-methoxyethyl) ammonium bis(trifluoromethylsulfonayl)imide. These room temperature ionic liquids possess relatively low viscosities.

As noted, the electrolyte composition also comprises a lithium ion. The lithium ion can be obtained, for example, by dissolving a lithium salt in the room temperature ionic liquid. Accordingly, in some examples, the lithium ion was obtained by dissolving, in the room temperature ionic liquid, one or more of lithium hexafluoroarsenate, lithium hexafluorophosphate, lithium nitrate, lithium perchlorate, lithium tetrafluoroborate, lithium tris(pentafluoroethyl)trifluorophosphate, lithium trifluoromethanesulfonate, lithium bis(fluorosulfonyl)imide, lithium cyclo-difluoromethane-1,1-bis(sulfonyl)imide, lithium cyclo-hexafluoropropane-1,1-bis(sulfonyl)imide, lithium bis(trifluoromethanesulfonyl)imide, lithium bis(perfluoroethanesulfonyl)imide, lithium bis(oxalate)borate, lithium difluoro(oxalato)borate, lithium bis(fluoromalonato)borate, lithium tetracyanoborate, lithium dicyanotriazolate, lithium dicyano-trifluoromethyl-imidazole, or, lithium dicyano-pentafluoroethyl-imidazole.

As noted, the electrolyte composition is interfused within the porous cross-linked polyimide network. Importantly, as mentioned above, it has been determined that the porous cross-linked polyimide networks are particularly amenable to interfusion with the electrolyte composition following synthesis as wet gels, as the solvents used in synthesis and/or storage of the wet gels can be exchanged efficiently with room temperature ionic liquids in the porous cross-linked polyimide networks. Accordingly, in some examples the electrolyte composition is interfused within the porous cross-linked polyimide network such that the polyimide network is in the form of a wet gel when the electrolyte composition is being interfused within the porous cross-linked polyimide network. Also in some examples the polyimide network has not been dried between synthesis and interfusion with the electrolyte composition. Also in some examples the electrolyte composition is interfused within the porous cross-linked polyimide network such that most or all of the solvent(s) used for preparation of the polyimide network are replaced by the room temperature ionic liquid, e.g. at least 80%, at least 90%, at least 95%, at least 99%, or 100% of the solvent(s) used for preparation of the polyimide network are replaced by the room temperature ionic liquid. This results in correspondingly efficient ionic transport of current during use.

Considering the structure of the porous cross-linked polyimide network in more detail, in some examples the porous cross-linked polyimide network has a porosity of 80 to 95%. Importantly, as mentioned above, by having porosities of 80 to 95% the cross-linked polyimide network may potentially contribute even less than current standard battery separators to the overall mass and volume of the voltaic cell, for improved efficiency in generation of current. The porosity of the porous cross-linked polyimide network can be determined, for example, by drying the porous cross-linked polyimide network to obtain a polyimide aerogel and measuring porosity of the aerogel, as described in Meador, U.S. Pat. No. 9,109,088. In some examples the porous cross-linked polyimide network can have a porosity of 85 to 95%, 90 to 95%, 91 to 95%, 92 to 95%, 93 to 95%, 94 to 95%, or 95%.

Turning to the structure of the polyimide-network battery-separator composition, in some examples the polyimide-network battery-separator composition is in the form of a film and has a film thickness of 0.0050 to 0.1000 cm. Importantly, the high mechanical strength, good thermal resistance, and chemical stability of the polyimide-network battery-separator composition can be exhibited and maintained when the polyimide-network battery-separator composition is in this form. In some of these examples the polyimide-network battery-separator composition in the form of a thin film can have sufficient flexibility to be rolled or folded and then recover completely without cracking or flaking. In some of these examples, the average degree of polymerization of the polyamic acid oligomer of the corresponding polyimide network can be, for example, 20 to 35. In some of these examples, the corresponding porous cross-linked polyimide networks can be tuned with respect to flexibility, making them suitable for standard lithium-based battery-separator formats ranging from flat-compressed formats to tightly-wound formats.

Turning to functional properties of the polyimide-network battery-separator composition, in some examples the polyimide-network battery-separator composition has an ionic conductivity, across the porous cross-linked polyimide network, of 1.0×10⁻⁴ to 8.0×10⁻³ S/cm at 25° C. Importantly, as mentioned above, ionic conductivities of CELGARD battery separators, which are current standard battery-separators, typically range from 1×10⁻² S/cm to 1×10⁻³ S/cm. Accordingly, the polyimide-network battery-separator composition can achieve conductivities overlapping the range for current standard battery separators. In some examples, the polyimide-network battery-separator composition has an ionic conductivity of 5.0×10⁻⁴ to 8.0×10⁻³ S/cm, 1.0×10⁻³ to 8.0×10⁻³ S/cm, or 5.0×10⁻³ to 8.0×10⁻³ S/cm, at 25° C.

Also in some examples the polyimide-network battery-separator composition has a wide thermal use window, e.g. a thermal use window extending up to 450° C., 475° C., 500° C., 525° C., 550° C., 575° C., 600° C., 625° C., or higher. This can be based, for example, on the porous cross-linked polyimide network having an onset of decomposition of at least 450° C., 475° C., 500° C., 525° C., 550° C., 575° C., 600° C., 625° C., or higher. For example, Meador et al., ACS Appl. Mater. Interfaces, vol. 4, pp. 536-544 (2012), reported that various TAB-crosslinked polyimide aerogels exhibited onsets of decomposition ranging from about 460 to 610° C. Meador (2012) also reported that onset of decomposition temperature varies with the diamine used, with PPDA providing the highest onset temperatures, and DMBZ providing the lowest onset temperatures, with the loss of the pendant methyl groups from DMBZ accounting for the difference. Also, Guo et al., ACS Appl. Mater. Interfaces, vol. 4, pp. 5422-5429 (2012), reported that various OAPS-crosslinked polyimide networks exhibited onsets of decomposition ranging from 525 to 625° C. Also, Meador et al., ACS Appl. Mater. Interfaces, vol. 7, pp. 1240-1249 (2015), reported that various 1,3,5-benzenetricarbonyl trichloride-crosslinked polyimide networks exhibited onsets of decomposition ranging from about 500 to 600° C. Also, Viggiano et al., ACS Appl. Mater. Interfaces, vol. 9, pp. 8287-8296 (2017), reported that additional 1,3,5-benzenetricarbonyl trichloride-crosslinked polyimide networks exhibited onsets of decomposition ranging from about 590 to 625° C. A wide thermal use window can decrease the risk of mechanical failure of the porous cross-linked polyimide network, and the corresponding polyimide-network battery-separator composition, due to decomposition.

A lithium-based voltaic cell also is provided. The lithium-based voltaic cell comprises a cathode, an anode, and the polyimide-network battery separator composition as described above. The lithium-based voltaic cell can be, for example, a lithium-ion voltaic cell, e.g. having a cathode comprising an intercalated lithium compound and being a secondary, i.e. rechargeable, voltaic cell. The lithium-based voltaic cell also can be, for example, a lithium-metal voltaic cell, e.g. having an anode comprising lithium metal and being a primary, i.e. non-rechargeable, voltaic cell. The lithium-based voltaic cell also can be, for example, a lithium-air voltaic cell, e.g. having an anode comprising lithium metal, having a cathode comprising a porous material having a high surface area, such as carbon, and using oxygen as active material. The lithium-based voltaic cell also can be, for example, a lithium-sulfur voltaic cell, e.g. having an anode comprising lithium metal, and having a carbon/sulfur cathode.

In some examples of the lithium-based voltaic cell the porous cross-linked polyimide network has a porosity of 80 to 95%. Also in some examples, the polyimide-network battery-separator composition is in the form of a film and has a film thickness of 0.0050 to 0.1000 cm. Also in some examples the polyimide-network battery-separator composition has an ionic conductivity, across the porous cross-linked polyimide network, of 1.0×10⁻⁴ to 8.0×10⁻³ S/cm at 25° C. Accordingly, in some examples the (i) the porous cross-linked polyimide network has a porosity of 80 to 95%, (ii) the polyimide-network battery-separator composition is in the form of a film and has a film thickness of 0.0050 to 0.1000 cm, and (iii) the polyimide-network battery-separator composition has an ionic conductivity, across the porous cross-linked polyimide network, of 1.0×10⁻⁴ to 8.0×10⁻³ S/cm at 25° C.

A lithium-based battery also is provided. The lithium-based battery comprises one or more of the lithium-based voltaic cells as described above, comprising a cathode, an anode, and the polyimide-network battery separator composition as described above. The lithium-based battery can be, for example, a lithium-ion battery, a lithium-metal battery, a lithium-air battery, or a lithium-sulfur battery, comprising one or more of a lithium-ion voltaic cell, a lithium-metal voltaic cell, a lithium-air voltaic cell, or a lithium-sulfur voltaic cell, also as described above.

Polyimide-Urea-Network Battery-Separator Compositions

A polyimide-urea-network battery-separator composition also is provided. The polyimide-urea-network battery-separator composition comprises (a) a porous cross-linked polyimide-urea network. The porous cross-linked polyimide-urea network comprises a subunit comprising two polyamic acid oligomers in direct connection via a urea linkage, wherein: (i) the polyamic acid oligomers (a) each comprise a repeating unit of a dianhydride and a diamine and a terminal functional group and (b) are formulated with 2 to 20 of the repeating units; (ii) the subunit was formed by reaction of the diamine and a diisocyanate to form a diamine-urea linkage-diamine group, followed by reaction of the diamine-urea linkage-diamine group with the dianhydride and the diamine to form the subunit; (iii) the subunit has been cross-linked via a cross-linking agent, comprising three or more cross-linking groups, at a balanced stoichiometry of the cross-linking groups to the terminal functional groups; and (iv) the subunit has been chemically imidized to yield the porous cross-linked polyimide-urea network. The polyimide-urea-network battery-separator composition also comprises (b) an electrolyte composition. The electrolyte composition comprises (i) a room temperature ionic liquid and (ii) a lithium ion. The electrolyte composition is interfused within the porous cross-linked polyimide network.

Considering the porous cross-linked polyimide-urea network in more detail, as noted the porous cross-linked polyimide-urea network comprises a subunit comprising two polyamic acid oligomers in direct connection via a urea linkage. By this it is meant that the porous cross-linked polyimide-urea network is made from molecules comprising two polyamic acid oligomers that are in direct connection with each other via a urea linkage.

As noted, the polyamic acid oligomers each comprise a repeating unit of a dianhydride and a diamine. A variety of dianhydrides and diamines can be used, as described above. Accordingly, in some examples the dianhydride can comprise one or more of BPDA, BTDA, pyromellitic dianhydride, or 2,2′-bis(3,4′-dicarboxyphenyl)hexafluoropropane dianhydride. Also in some examples the diamine can comprise one or more of DMBZ, 4,4′-ODA, 3,4-ODA, PPDA, BAX, 4,4′-bis(4-am inophenoxy)biphenyl, 3,3′-bis(4-am inophenoxy)biphenyl, 4,4′-(1,4-phenylenediisopropylidene)bisaniline, 4,4′-(1,3-phenylenediisopropylidene)bisaniline, or ED600. Additional suitable diamines include m-phenylenediamine, BAPD, bisaniline-M, and HFBAPP. Again, the dianhydride and/or diamine can be selected based on being known to impart different properties to polyim ides in general, and to cross-linked polyimide-urea networks in particular, e.g. for tuning cross-linked polyimide-urea networks with respect to flexibility, hydrophobicity and wettability, and/or to shrink to varying extents at temperatures intended to serve as shut-off temperatures. Again, two or more dianhydrides and/or two or more diamines can also be used in combination.

As noted, the polyamic acid oligomers also each comprise a terminal functional group. A variety of terminal functional groups also can be used, as described above. For example, the terminal functional groups can comprise (i) terminal anhydride groups, such that the polyamic acid oligomer comprises an anhydride end-capped polyamic acid oligomer, (ii) terminal amine groups, such that the polyamic acid oligomer comprises an amine end-capped polyamic acid oligomer, or (iii) terminal anhydride groups and terminal amine groups.

As noted, the polyamic acid oligomers are formulated with 2 to 20 of the repeating units. In some examples, the polyamic acid oligomers can be formulated with 3 to 15, or 4 to 9, or 5 to 7, or 6 of the repeating units.

As noted, the subunit was formed by reaction of the diamine and a diisocyanate to form a diamine-urea linkage-diamine group, followed by reaction of the diamine-urea linkage-diamine group with the dianhydride and the diamine to form the subunit. The diisocyanate can be, for example, 4,4′-methylene-bis-diphenyldiisocyanate (“MDI”). Like the dianhydride and/or diamine, the diisocyanate can be selected based on being known to impart different properties to cross-linked polyimide-urea networks, again to tune cross-linked polyimide-urea networks with respect to flexibility, hydrophobicity and wettability, and/or to shrink to varying extents at temperatures intended to serve as shut-off temperatures. The reaction of the diamine and the diisocyanate to form the diamine-urea linkage-diamine group can be carried out with an excess of diamine to isocyanate groups of the diisocyanate in order to ensure amine-end capping of all of the isocyanate groups thereof.

The reaction of the resulting diamine-urea linkage-diamine group with the dianhydride and the diamine to form the subunit can then be carried out by adding the dianhydride in order to form and extend polyamic acid oligomers, one from each of the two isocyanate groups of each molecule of diisocyanate.

This reaction can be carried out such that there is a balanced stoichiometry of both the diamine and the dianhydride that has been added. Carrying out the reaction at a balanced stoichiometry of the diamine and the dianhydride results in extension of polyamic acid oligomers from the diamine-urea linkage-diamine groups, with each polyamic acid oligomer comprising a terminal anhydride group, i.e. being anhydride end-capped. As one of ordinary skill will also appreciate, a balanced stoichiometry need not be precisely balanced with respect to the molar ratio, but rather can tolerate some variation, e.g. plus or minus 10%, so long as most, e.g. essentially all, of the resulting polyamic acid oligomers comprise a terminal anhydride group.

This reaction can also be carried out at a predetermined molar ratio of resulting repeating units of the dianhydride and the diamine to the isocyanate groups of each molecule of diisocyanate. Carrying out the reaction at a predetermined molar ratio of the resulting repeating units to the isocyanate groups allows control of the number of repeating units with which the resulting anhydride end-capped polyamic acid oligomers are formulated. For example, by carrying out the reaction at a predetermined molar ratio of 6 of the repeating units per isocyanate group, the resulting anhydride end-capped polyamic acid oligomers will have an average of 6 of the repeating units. This can be accomplished, for example, by adding a total of 6 molar equivalents of the diamine and 6 molar equivalents of the dianhydride per isocyanate group, with the diamine and diisocyanate first being combined in a single composition to react and form the diamine-urea linkage-diamine group, followed by addition of the dianhydride, resulting in reaction of the dianhydride with remaining excess diamine to form and extend the polyamic acid oligomers, one from each of the two isocyanate groups of each molecule of diisocyanate. Moreover, by carrying out the reaction at a higher predetermined molar ratio, e.g. 7, 8, 9, 10, 11, 12, 13, 14, or 15, the resulting anhydride end-capped polyamic acid oligomers can have a higher average number of the repeating units, e.g. 7, 8, 9, 10, 11, 12, 13, 14, or 15, respectively. In addition, by carrying out the reaction at a lower predetermined molar ratio, e.g. 5, 4, 3, or 2, the resulting anhydride end-capped polyamic acid oligomers can have a lower average number of the repeating units, e.g. 5, 4, 3, or 2, respectively.

Conditions suitable for these reactions are described in Meador et al., U.S. Pat. No. 8,974,903.

As noted, the subunit has been cross-linked via a cross-linking agent. By this it is meant that molecules of the subunit have been cross-linked to each other via the cross-linking agent.

As noted, the cross-linking agent comprises three or more cross-linking groups. For example, the three or more cross-linking groups can comprise one or more of isocyanate groups, amine groups, or acid chloride groups, as described above. Moreover, the cross-linking agents can be those described above. In addition, the cross-linking agent can be selected based on being known to impart different properties to cross-linked polyimide-urea networks, again in order to tune cross-linked polyimide-urea networks with respect to flexibility, hydrophobicity and wettability, and/or to shrink to varying extents at temperatures intended to serve as shut-off temperatures.

As noted, the cross-linking is carried out at a balanced stoichiometry of the cross-linking groups of the cross-linking agent to the terminal functional group of the polyamic acid oligomer. For example, for a cross-linking agent comprising three amine groups and a subunit comprising two polyamic acid oligomers, each polyamic acid oligomer comprising a terminal anhydride group, in order to obtain a precisely balanced stoichiometry the molar ratio of the cross-linking agent to the subunit would be 2:3. As one of ordinary skill in the art will appreciate, carrying out the cross-linking at a balanced stoichiometry provides a cross-linked gel. This is in contrast to an imbalanced stoichiometry, which provides comb polymers that probably would not gel. Accordingly, as one of ordinary skill will also appreciate, a balanced stoichiometry need not be precisely balanced with respect to the molar ratio, but rather can tolerate some variation, e.g. plus or minus 10%, so long as the cross-linking provides a cross-linked gel. Conditions suitable for the cross-linking described in Meador et al., U.S. Pat. No. 8,974,903.

As noted, the subunit has been chemically imidized to yield the porous cross-linked polyimide-urea network. The chemical imidization can be carried out, for example, by use of an imidization catalyst, as described above, including for example that the polyamic acid oligomer can be chemically imidized to completion.

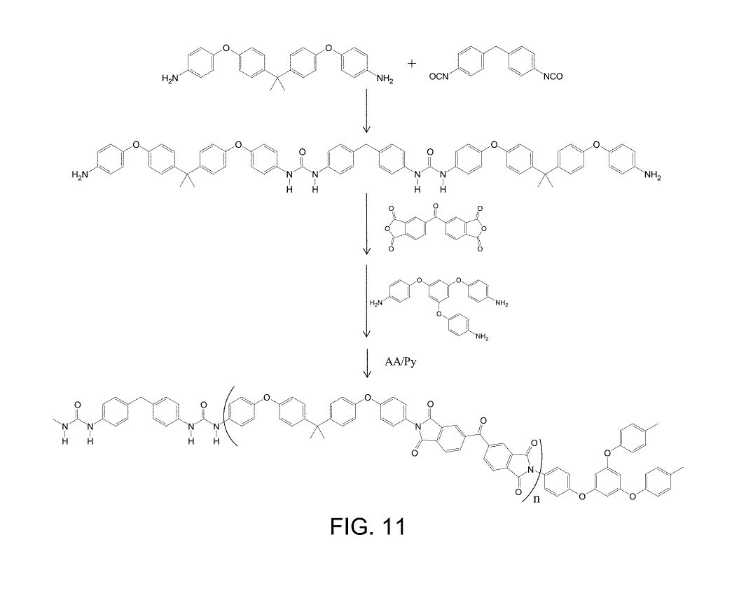

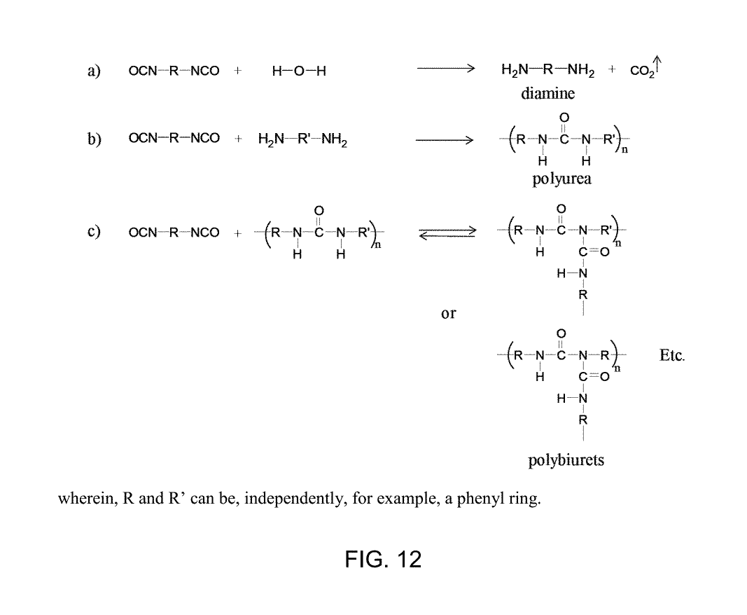

A scheme for synthetic routes of an exemplary porous cross-linked polyimide-urea network is provided in FIG. 11. Specifically, FIG. 11 provides details of a polyimide-urea network made from BTDA, BAPP, and MDI, and cross-linked with TAB. A scheme of general reaction of isocyanate with water, aromatic diamine, and side products is provided in FIG. 12.

The porous cross-linked polyimide-urea network can be synthesized as described, for example, in Meador et al., U.S. Pat. No. 8,974,903, which describes use of terminal functional groups comprising terminal anhydride groups and cross-linking agents comprising amine groups.

An exemplary method for making the porous cross-linked polyimide-urea network is as follows. The method comprises reacting (i) the diamine and a diisocyanate to form a diamine-urea linkage-diamine group, (ii) reacting the diamine-urea linkage-diamine group with the dianhydride and the diamine to form the subunit, (iii) cross-linking the subunit with a cross-linking agent, comprising three or more amine groups, at a balanced stoichiometry of the amine groups to the terminal anhydrides, and (iv) chemically imidizing the subunit with an imidization catalyst to yield the porous cross-linked polyimide-urea network. In accordance with this exemplary method, the cross-linking agent can comprise one or more of a triamine, an aliphatic triamine, an aromatic triamine, 1,3,5-tri(4-aminophenoxy)benzene, a silica cage structure decorated with three or more amines, octa(aminophenyl)silsesquioxane, octa(aminophenyl)silsesquioxane as a mixture of isomers having the ratio meta:ortho:para of 60:30:10, and para-octa(aminophenyl)silsesquioxane. The subunit can be chemically imidized to completion, and/or the imidization catalyst can comprise, for example, acetic anhydride and pyridine, as discussed above.

The porous cross-linked polyimide-urea network can be synthesized as a wet gel comprising the porous cross-linked polyimide-urea network. Along with the polyimide-urea network, the wet gel can comprise a solvent that was used for preparation of the polyimide-urea network. Solvents that can be used for preparation of the polyimide-urea network include, for example, NMP, DMF, and DMAc.

Turning to the electrolyte composition, as noted the electrolyte composition comprises a room temperature ionic liquid. A variety of room temperature ionic liquids can be used, as described above. For example, the room temperature ionic liquid can comprise one or more of 1-methyl-1-propylpyrrolidinium bis(trifluoromethylsulfonayl)imide, 1-butyl-1-methylpyrrolidinium bis(trifluoromethylsulfonayl)imide, 1-ethyl-3-methylimidazolium bis(trifluoromethylsulfonyl)imide, 1-ethyl-3-methylimidazolium triflate, 1-ethyl-3-methylimidazolium tetraborate, 1,3-diethylimidazolium bis(trifluoromethylsulfonyl)imide, 1-methyl-3-propylimidazolium bis(trifluoromethylsulfonyl)imide, butyltrimethylammonium bis(trifluoromethylsulfonayl)imide, 1-(2-methoxyethyl)-3-methylimidazolium bis(trifluoromethylsulfonyl)imide, diethylmethylammonium trifluoromethanesulfonate, 1-allyl-3-methylim idazolium bis(trifluoromethylsulfonyl)imide, or N,N-diethyl-N-methyl-N-(2-methoxyethyl) ammonium bis(trifluoromethylsulfonayl)imide.

The electrolyte composition also comprises a lithium ion. The lithium ion can be obtained, for example, by dissolving a lithium salt in the room temperature ionic liquid, as described above. Accordingly, in some examples, the lithium ion was obtained by dissolving, in the room temperature ionic liquid, one or more of lithium hexafluoroarsenate, lithium hexafluorophosphate, lithium nitrate, lithium perchlorate, lithium tetrafluoroborate, lithium tris(pentafluoroethyl)trifluorophosphate, lithium trifluoromethanesulfonate, lithium bis(fluorosulfonyl)imide, lithium cyclo-difluoromethane-1,1-bis(sulfonyl)imide, lithium cyclo-hexafluoropropane-1,1-bis(sulfonyl)imide, lithium bis(trifluoromethanesulfonyl)imide, lithium bis(perfluoroethanesulfonyl)imide, lithium bis(oxalate)borate, lithium difluoro(oxalato)borate, lithium bis(fluoromalonato)borate, lithium tetracyanoborate, lithium dicyanotriazolate, lithium dicyano-trifluoromethyl-imidazole, or, lithium dicyano-pentafluoroethyl-imidazole.

As noted, the electrolyte composition is interfused within the porous cross-linked polyimide-urea network. Similarly as described above, in some examples the electrolyte composition is interfused within the porous cross-linked polyimide-urea network such that the polyimide-urea network is in the form of a wet gel when the electrolyte composition is being interfused within the porous cross-linked polyimide-urea network. Also in some examples the polyimide-urea network has not been dried between synthesis and interfusion with the electrolyte composition. Also in some examples the electrolyte composition is interfused within the porous cross-linked polyimide-urea network such that most or all of the solvent(s) used for preparation of the polyimide-urea network are replaced by the room temperature ionic liquid, e.g. at least 80%, at least 90%, at least 95%, at least 99%, or 100% of the solvent(s) used for preparation of the polyimide network are replaced by the room temperature ionic liquid.

Considering the structure of the porous cross-linked polyimide-urea network in more detail, in some examples the porous cross-linked polyimide-urea network has a porosity of 80 to 95%. In some examples the porous cross-linked polyimide-urea network can have a porosity of 85 to 95%, 90 to 95%, 91 to 95%, 92 to 95%, 93 to 95%, 94 to 95%, or 95%.

Turning to the structure of the polyimide-urea-network battery-separator composition, in some examples the polyimide-urea-network battery-separator composition is in the form of a film and has a film thickness of 0.0050 to 0.1000 cm. Similarly as described above, in some of these examples the polyimide-urea-network battery-separator composition in the form of a thin film can have sufficient flexibility to be rolled or folded and then recover completely without cracking or flaking. In some of these examples, the corresponding polyamic acid oligomers of the polyim ide-urea-network can be formulated with 3 to 15, or 4 to 9, or 5 to 7, or 6, of the repeating units. In some of these examples, the corresponding porous cross-linked polyimide-urea networks can be tuned with respect to flexibility, making them suitable for standard lithium-based battery-separator formats ranging from flat-compressed formats to tightly-wound formats.

Turning to functional properties of the polyimide-urea-network battery-separator composition, in some examples the polyimide-urea-network battery-separator composition has an ionic conductivity, across the porous cross-linked polyimide-urea network, of 1.0×10⁻⁴ to 8.0×10⁻³ S/cm at 25° C. In some examples, the polyimide-urea-network battery-separator composition has an ionic conductivity of 5.0×10⁻⁴ to 8.0×10⁻³ S/cm, 1.0×10⁻³ to 8.0×10⁻³ S/cm, or 5.0×10⁻³ to 8.0×10⁻³ S/cm, at 25° C. Also in some examples the polyimide-urea-network battery-separator composition has a wide thermal use window, e.g. a thermal use window extending up to 450° C., 475° C., 500° C., 525° C., 550° C., 575° C., 600° C., 625° C., or higher.

Another lithium-based voltaic cell also is provided. The other lithium-based voltaic cell comprises a cathode, an anode, and the polyimide-urea network battery separator composition as described above. The other lithium-based voltaic cell can be, for example, a lithium-ion voltaic cell, a lithium-metal voltaic cell, a lithium-air voltaic cell, or a lithium-sulfur voltaic cell, as described above. In some examples of the other lithium-based voltaic cell the porous cross-linked polyimide-urea network has a porosity of 80 to 95%, the polyimide-urea-network battery-separator composition is in the form of a film and has a film thickness of 0.0050 to 0.1000 cm, and/or the polyimide-urea-network battery-separator composition has an ionic conductivity, across the porous cross-linked polyimide-urea network, of 1.0×10⁻⁴ to 8.0×10⁻³ S/cm at 25° C., as described above.

Another lithium-based battery also is provided. The other lithium-based battery comprises one or more of the other lithium-based voltaic cells as described above, comprising a cathode, an anode, and the polyimide-urea-network battery separator composition as described above. The other lithium-based battery can be, for example, a lithium-ion battery, a lithium-metal battery, a lithium-air battery, or a lithium-sulfur battery, comprising one or more of a lithium-ion voltaic cell, a lithium-metal voltaic cell, a lithium-air voltaic cell, or a lithium-sulfur voltaic cell, also as described above.

### EXAMPLES

### Example 1

Synthesis of Porous Cross-Linked Polyimide and Polyimide-Urea Networks

Porous cross-linked polyimide and polyimide urea networks were prepared as shown in the schemes presented in FIG. 4, FIG. 6, FIG. 7, and FIG. 8, where n is the formulated number of repeat units in the oligomers between cross-links.

In a typical reaction, a diamine (e.g. either DMBZ or ODA, or a 50:50 mol % mixture of both DMBZ and ODA), was first dissolved in NMP. A dianhydride (e.g. BPDA), in powder form, was added and stirred until all was dissolved. A cross-linking agent (e.g. N3300A), dissolved in NMP, was then added to the oligomer solution. Once the solution became homogeneous, acetic anhydride and triethylamine were added in sequence. Gelation occurred between 30 to 50 min, depending on the formulation. Higher polymer concentration gelled faster.

(a) Synthesis of N3300A Cross-Linked ODA-BPDA Polyimide Network Gel

Polymer concentration was formulated of 10 wt % with repeat units of 60. The synthesis procedure is as follows: ODA (2.18 g, 10.9 mmol) was first dissolved in 40.0 ml NMP. BPDA (3.15 g, 10.7 mmol) was then added. The reaction was stirred at room temperature until BPDA was totally dissolved. The cross-linker, Desmodur N3300A (0.0600 g, 0.119 mmol), dissolved in 3.80 ml NMP, was mixed into the poly(amic acid) solution for about 1 min or until a homogenous solution was obtained. Acetic anhydride (8.09 mml, 85.6 mmol) was then added, followed by triethylamine (2.98 ml, 21.4 mmol). Viscosity increased with time. The solution was stirred for 20 minutes before casting into thin film. Gelation occurred in 30 min. The gels were sealed to avoid evaporation of solvent and allowed to age at room temperature for a day. The NMP in the wet gels was gradually removed by solvent exchange with acetone by first soaking gels in 75 v/v % NMP in acetone, then 25 v/v % NMP in acetone, followed by four more immersions in 100% fresh acetone in half day increments.

(b) Synthesis of TAB Cross-Linked ODA-BPDA Polyimide Network Gel

Polymer concentration was formulated of 10 wt % with repeat units of 40. The synthesis procedure is as follows: ODA (2.12 g, 10.6 mmol) was first dissolved in 40.0 ml NMP. BPDA (3.20 g, 10.9 mmol) was then added. The reaction was stirred at room temperature until BPDA was totally dissolved. The cross-linker, TAB, (0.0706 g, 0.177 mmol), dissolved in 3.80 ml NMP, was mixed into the poly(amic acid) solution for about 1 min or until a homogenous solution was obtained. Acetic anhydride (8.22 mml, 87.2 mmol) was then added, followed by triethylamine (3.03 ml, 21.8 mmol). Viscosity increased with time. The solution was stirred for 50 minutes before casting into thin film. Gelation occurred in 10 min. The gels were sealed to avoid evaporation of solvent and allowed to age at room temperature for a day. The NMP in the wet gels was gradually removed by solvent exchange with acetone by first soaking gels in 75 v/v % NMP in acetone, then 25 v/v % NMP in acetone, followed by four more immersions in 100% fresh acetone in half day increments.

(c) Synthesis of N3300A Cross-Linked ODA-BPDA Polyimide-Urea Network Gel

Polymer concentration was formulated of 10 wt % with repeat units of 30. The synthesis procedure is as follows: MDI (0.0865 g, 0.349 mmol) was first dissolved in 37.00 ml of NMP. ODA (2.09 g, 10.5 mmol) was added. Once all ODA was in solution, BPDA (3.08 g, 10.5 mmol) was then introduced and the reaction was stirred at room temperature until BPDA was totally dissolved. The cross-linker, N3300A (0.1173 g, 0.233 mmol), in 3.00 ml NMP, was mixed into the poly(amic acid) solution for about 1 min or until a homogenous solution was obtained. Acetic anhydride (7.90 mml, 83.57 mmol) was then added, followed by triethylamine (2.00 ml, 20.89 mmol). Viscosity increased with time. The solution was stirred for 6 minutes before casting into thin film. Gelation occurred in about 8 min. The gels were sealed to avoid evaporation of solvent and allowed to age at room temperature for a day. The NMP in the wet gels was gradually removed by solvent exchange with acetone by first soaking gels in 75 v/v % NMP in acetone, then 25 v/v % NMP in acetone, followed by four more immersions in 100% fresh acetone in half day increments.

(d) Synthesis of TAB Cross-Linked Polyimide Gel (ED600-ODA)-BPDA Polyimide Network Gel Containing 50 Mol % ED600 and 50 Mol % ODA

Polymer concentration was formulated of 10 wt % with repeat units of 30. The synthesis procedure is as follows: JEFFAMINE (R) ED600 (2.22 g, 3.70 mmol) was first dissolved in 40.00 ml of NMP. BPDA (2.25 g, 7.65 mmol) was added and stirred for 30 minutes. ODA (0.74 g, 3.70 mmol) was added then introduced to the mixture. The reaction was stirred at room temperature until BPDA was totally dissolved. The cross-linker, TAB (0.0656 g, 0.164 mmol), in 3.80 ml NMP, was mixed into the poly(amic acid) solution for about 1 min or until a homogenous solution was obtained. Acetic anhydride (5.80 mml, 61.15 mmol) was then added, followed by triethylamine (2.13 ml, 15.28 mmol). Viscosity increased with time. The solution was stirred for 20 minutes before casting into thin film. Gelation occurred in about 25 min. The gels were sealed to avoid evaporation of solvent and allowed to age at room temperature for a day. The NMP in the wet gels was gradually removed by solvent exchange with acetone by first soaking gels in 75 v/v % NMP in acetone, then 25 v/v % NMP in acetone, followed by four more immersions in 100% fresh acetone in half day increments.

(e) Synthesis of TAB Cross-Linked DMBZ-BTDA Polyimide Gel Containing MDI

Polymer concentration was formulated of 8.5 wt % with repeat units of 30. The synthesis procedure is as follows: MDI (0.0720 g, 0.291 mmol) was first dissolved in 38.00 ml of NMP. DMBZ (1.85 g, 8.72 mmol) was added. Once all DMBZ was in solution, BPDA (2.56 g, 8.72 mmol) was then introduced and the reaction was stirred at room temperature until BPDA was totally dissolved. The cross-linker, TAB (0.0774 g, 0.0.194 mmol), in 3.20 ml NMP, was mixed into the poly(amic acid) solution for about 1 min or until a homogenous solution was obtained. Acetic anhydride (6.60 mml, 69.81 mmol) was then added, followed by triethylamine (2.45 ml, 17.58 mmol). Viscosity increased with time. The solution was stirred for 8 minutes before casting into thin film. Gelation occurred in about 10 min. The gels were sealed to avoid evaporation of solvent and allowed to age at room temperature for a day. The NMP in the wet gels was gradually removed by solvent exchange with acetone by first soaking gels in 75 v/v % NMP in acetone, then 25 v/v % NMP in acetone, followed by four more immersions in 100% fresh acetone in half day increments.

Process of Imbibing Cross-Linked Polyimide Gels in Room Temperature Ionic Liquids

The amount of salt content in a selected electrolyte composition was prepared by adding 10 to 20 g of lithium bis(trifluoromethane)sulfonamide salt (also termed “Li TFSI” or lithium bis(trifluoromethylsulfonyl)imide) to 100 g of room temperature ionic liquid, resulting in electrolyte compositions of Li TFSI at 9.09 wt % or 18.18 wt % respectively.

The electrolyte composition was added to a container of porous cross-linked polyimide or polyimide-urea network gel, in acetone, in a ratio of 2:1 vol % of electrolyte composition:acetone. The solution was mixed gently until homogeneous and the polyimide or polyimide-urea network gel film was soaked in the mixture for 1 to 2 days, depending on the viscosity of the electrolyte composition. The acetone was then evaporated for about 3 to 5 days, leaving the film completely imbibed with the electrolyte composition.

### Example 2

A diverse set of polyimide-network battery-separator compositions and polyimide-urea-network battery-separator compositions were prepared. Details of the corresponding cross-linked polyimide networks, cross-linked polyimide-urea networks, and room temperature ionic liquids are provided in Table 1, Table 2, and Table 3. Lithium salts suitable for use with lithium-based batteries are listed in Table 4.

The polyimide-network battery-separator compositions and polyimide-urea-network battery-separator compositions were tested with respect to ionic conductivity, film thickness, porosity, compression modulus, tensile modulus, and/or viscosity. Results also are provided in Table 1 and Table 2.

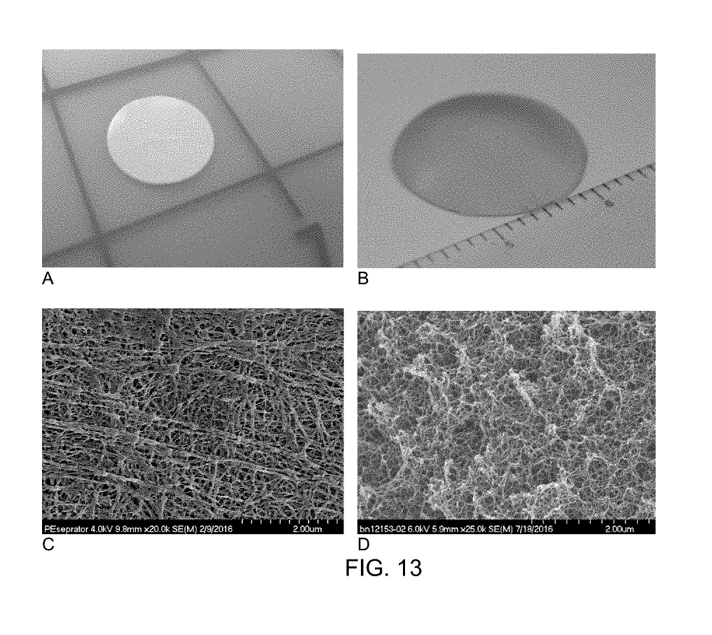

A comparison of a CELGARD battery separator and a polyimide-network battery-separator composition including a polyimide network corresponding to ODA-BPDA-N3300A was made, including photographs and scanning electron micrographs, as shown in FIG. 13. The comparison suggests that the polyimide network corresponding to ODA-BPDA-N3300A has a porosity similar to that of the CELGARD battery separator.

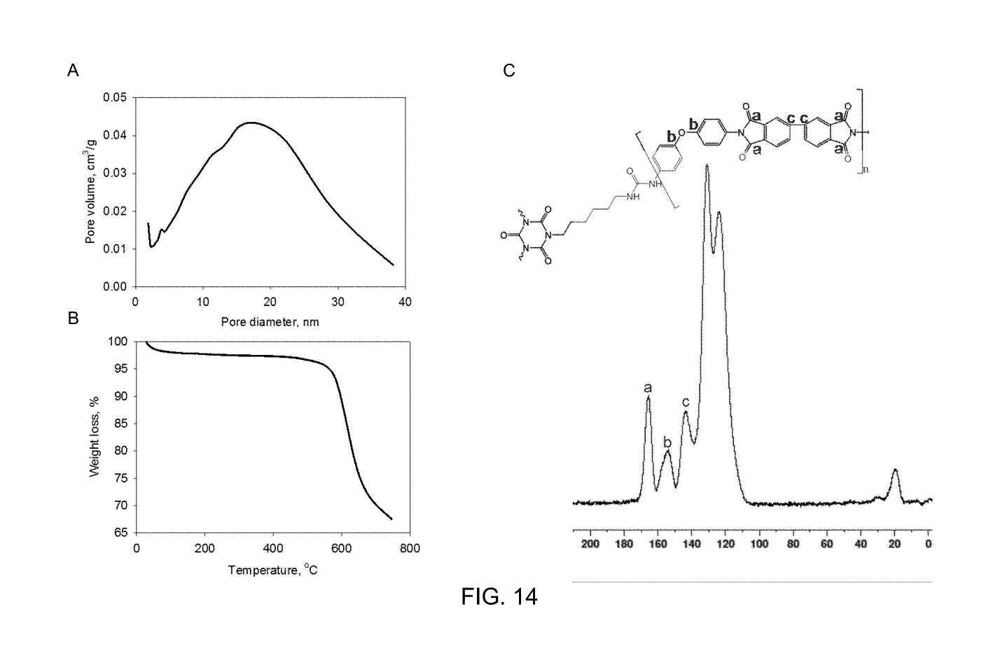

Physical characteristics of the polyimide network corresponding to ODA-BPDA-N3300A, including pore volume (cm³/g) per pore diameter (nm), weight loss (%) per temperature (° C.), and C-13 NMR spectrum were determined, as shown in FIG. 14. The results indicate that the ODA-BPDA-N3300A polyimide network exhibits thermal stability to approximately 500° C., demonstrating a wide thermal use regime. This is consistent with results reported previously for other porous cross-linked polyimide networks, as discussed above. The results also confirm the structure of the ODA-BPDA-N3300A polyimide network.

All room temperature ionic liquids tested with the ODA-BPDA-N3300A polyimide network wetted the polyimide network well.

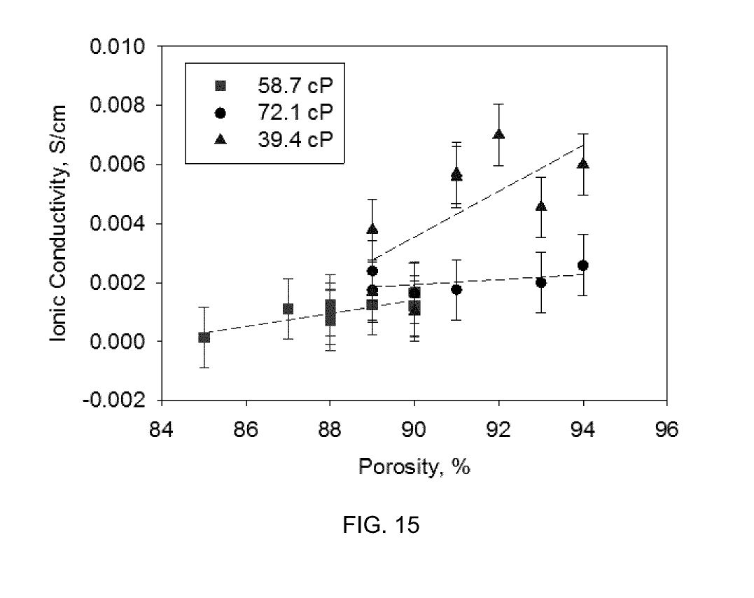

Ionic conductivity (S/cm) versus porosity (%) of various polyimide networks was measured for polyimide-network battery-separator compositions including room temperature ionic liquids spanning a range of viscosities, specifically 1-methyl-1-propylpyrrolidinium bis(trifluoromethylsulfonyl)imide having a viscosity of 58.7 cP, 1-butyl-1-methylpyrrolidinium bis(trifluoromethylsulfonyl)imide having a viscosity of 72.1 cP, and 1-ethyl-3-methylimidazolium bis(trifluoromethylsulfonyl)imide having a viscosity of 39.4 cP, as shown in FIG. 15. The corresponding lithium salt was Li TFSI. The results indicate that ionic conductivity increases with increasing porosity of the polyimide network and decreasing viscosity of the room temperature ionic liquid.

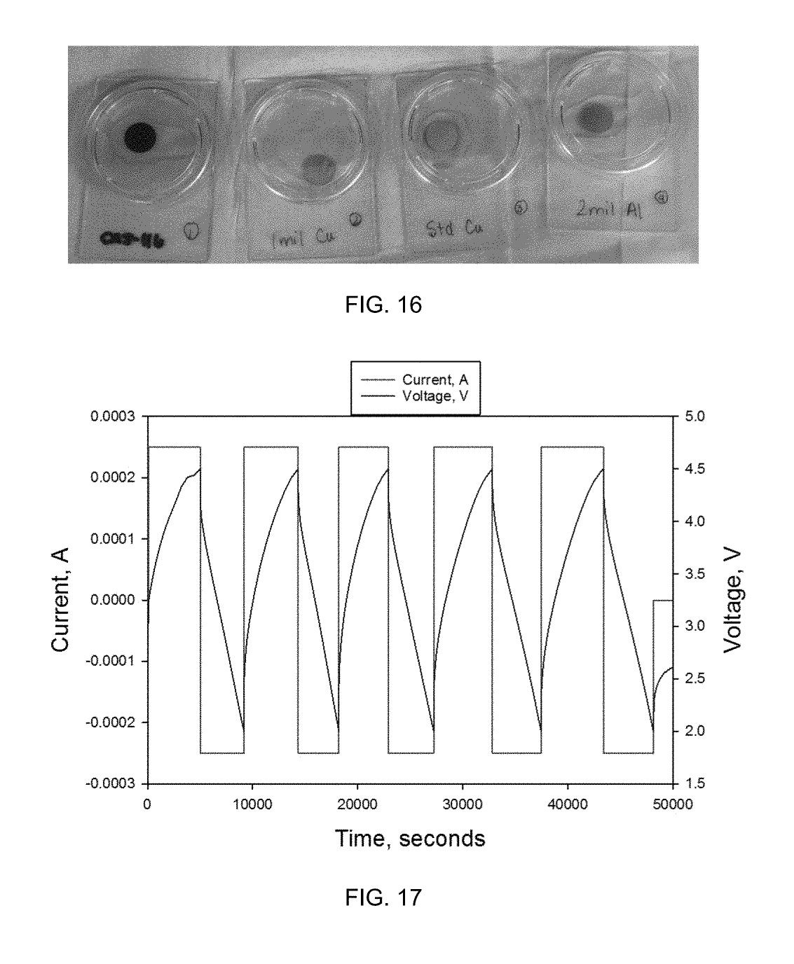

Stability of the room temperature ionic liquid 1-ethyl-3-methylimidazolium bis(trifluoromethylsulfonyl)imide in the presence of an aluminum cathode and a copper anode was tested, with stability demonstrated based on an absence of visible discoloration or reaction, as shown in FIG. 16. The results indicate that the room temperature ionic liquid 1-ethyl-3-methylimidazolium bis(trifluoromethylsulfonyl)imide was stable under these conditions.

Current (red) and voltage (blue) versus time (seconds) were determined for a polyimide-network battery-separator composition including the ODA-BPDA-N3300A polyimide network and the room temperature ionic liquid 1-ethyl-3-methylimidazolium bis(trifluoromethylsulfonyl)imide that was cycled for 14 hours with an aluminum cathode and a copper anode, as shown in FIG. 17. The results indicate that the polyimide-network battery-separator composition was stable.

A polyimide-network battery-separator composition including the ODA-BPDA-N3300A polyimide network and the room temperature ionic liquid 1-ethyl-3-methylimidazolium bis(trifluoromethylsulfonyl)imide was tested for flammability under direct exposure to flame. The polyimide-network battery-separator composition charred, but did not burn. The results indicate that the polyimide-network battery-separator composition including the ODA-BPDA-N3300A polyimide network and the room temperature ionic liquid 1-ethyl-3-methylimidazolium bis(trifluoromethylsulfonyl)imide is not flammable under direct exposure to flame. The ODA-BPDA-N3300A polyimide network also shrank, demonstrating a shut-off temperature.

Accordingly, a polyimide-network battery-separator composition including a cross-linked porous polyimide network and a room temperature ionic liquid has been made. It was observed that ionic conductivity increased as a function of increasing porosity of the polyimide network and decreasing viscosity of the room temperature ionic liquid. The room temperature ionic liquid 1-ethyl-3-methylimidazolium bis(trifluoromethylsulfonyl)imide showed no visible reaction with an aluminum cathode and a copper anode. A corresponding polyimide-network battery-separator composition including the ODA-BPDA-N3300A polyimide network and the room temperature ionic liquid 1-ethyl-3-methylimidazolium bis(trifluoromethylsulfonyl)imide cycled for 14 hours with the aluminum cathode and the copper anode. The polyimide-network battery-separator composition including the ODA-BPDA-N3300A polyimide network and the room temperature ionic liquid 1-ethyl-3-methylimidazolium bis(trifluoromethylsulfonyl)imide was not flammable under direct exposure to flame. The polyimide-network battery-separator composition also shrank, demonstrating a shut-off temperature. These results suggest that the polyimide-network battery-separator compositions and the polyimide-urea-network battery-separator compositions disclosed herein are structurally and functionally suitable for use as battery separators in lithium-based voltaic cells, and offer the possibility of safer and more efficient operation of lithium-based batteries relative to current standard battery separators.

TABLE 1
Formulations and properties of polyimide-network battery-separator compositions and polyimide-urea-network battery-separator compositions, in
which salt corresponds to lithium bis(trifluoromethane)sulfonamide salt (also termed “Li TFSI” or lithium bis(trifluoromethylsulfonyl)imide).*

| | | | | | | | | Tensile |
|---|---|---|---|---|---|---|---|---|
| | Chemical Formula: | | Room | | | | Compres- | Modulus, |
| | Diamine/(Diisocyanate or | Salt (g/100 g | Temp. | | Film | % | sion | Mpa |
| | Additional Diamine)/ | Room Temp. | Ionic | Ionic | thickness, | Poros- | Modulus, | (dog- |
| Sample I.D. | Dianhydride/Cross-Linker | Ionic Liquid) | Liquid | Conductivity | cm | ity | Mpa | bone) |
| bn12.121.01 | DMBZ/(ED600)/BPDA/N3300A | 10 | RTIL 1 | 5.59 × 10⁻⁴ | 0.0213 | — | — | — |
| | (n = 30) | | | S/cm | | | | |
| bn12.123.02 | BAPP/(MDI)/BTDA/TAB | 10 | RTIL 1 | 1.24 × 10⁻³ | 0.0327 | 88 | — | 52.44 |
| | (n = 30) | | | S/cm | | | | |
| bn12.123.02 | BAPP/(MDI)/BTDA/TAB | 10 | RTIL 1 | 7.22 × 10⁻⁴ | 0.0222 | 88 | — | 52.44 |
| (dry film) | (n = 30) | | | S/cm | | | | |
| bn12.125.01 | ODA/(ED600)/BPDA/N3300A | 10 | RTIL 1 | 1.67 × 10⁻³ | 0.0320 | 90 | — | — |
| (dry film) | | | | S/cm | | | | |
| bn12.131.01 | DMBZ/BPDA/TAB | 10 | RTIL 1 | 1.22 × 10⁻³ | 0.0586 | 90 | — | — |
| | (n = 30) | | | S/cm | | | | |
| bn12.131.04 | DMBZ/BTDA/TAB | 10 | RTIL 1 | 9.47 × 10⁻⁴ | 0.0646 | 88 | — | — |
| | (n = 30) | | | S/cm | | | | |
| bn12.131.11 | DMBZ/(MDI)/BTDA/TAB | 20 | RTIL 1 | 7.33 × 10⁻⁴ | 0.0831 | 88 | — | — |
| | (n = 30) | | | S/cm | | | | |
| bn12.131.11 | DMBZ/(MDI)/BTDA/TAB | 20 | RTIL 1 | 6.92 × 10⁻⁴ | — | 88 | — | — |
| (dried in air) | | | | S/cm | | | | |
| bn12.131.19 | BAPP/BTDA/TAB | 20 | RTIL 1 | 1.10 × 10⁻³ | 0.0991 | 87 | 106.7 | 121.65 |
| | (n = 30) | | | S/cm | | | | |
| bn12.131.19 | BAPP/BTDA/TAB | 20 | RTIL 1 | 5.05 × 10⁻⁴ | — | 87 | 106.7 | 121.65 |
| (dried in air) | | | | S/cm | | | | |
| bn12.131.29 | DMBZ/(MDI)/BPDA/TAB | 20 | RTIL 1 | 1.20 × 10⁻³ | 0.0780 | 90 | — | — |
| | (n = 30) | | | S/cm | | | | |
| bn12.131.29 | DMBZ/(MDI)/BPDA/TAB | 20 | RTIL 1 | 3.98 × 10⁻⁴ | — | 90 | — | — |
| (dried in air) | | | | S/cm | | | | |
| bn12.131.34/CD01-19-02 | DMBZ/BTDA/TAB | 20 | RTIL 1 | 7.35 × 10⁻⁴ | 0.0856 | 85 | 100.88 | 201.31 |
| | (n = 30) | | | S/cm | | | | |
| bn12.131.34 | DMBZ/BTDA/TAB | 20 | RTIL 1 | 4.54 × 10⁻⁴ | — | 85 | 100.88 | 201.31 |
| (dried in air) | | | | S/cm | | | | |
| bn12.141.02 | ODA/(ED600)/BPDA/TAB | 20 | RTIL 1 | 9.64 × 10⁻⁴ | 0.0678 | 89 | — | — |
| | (n = 30) | | | S/cm | | | | |
| bn12.141.02 | ODA/(ED600)/BPDA/TAB | 20 | RTIL 1 | 7.89 × 10⁻⁴ | — | — | — | — |
| (dried in air) | (n = 30) | | | S/cm | | | | |
| | ODA/(MDI)/BPDA/N3300A | 20 | RTIL 1 | 1.25 × 10⁻³ | 0.0650 | 89 | — | — |
| | | | | S/cm | | | | |
| bn12.149.01 | ODA/(MDI)/BPDA/N3300A | 20 | RTIL 1 | 6.99 × 10⁻⁴ | — | 89 | — | — |
| (dried in air) | | | | S/cm | | | | |
| bn12.177.11 | DMBZ/(MDI)/BPDA/Desmodur | 20 | RTIL 3 | 9.36 × 10⁻⁴ | 0.0524 | — | — | — |
| (dry film) | Z4470 (n = 30) | | | S/cm | | | | |
| bn12-177.12 | DMBZ/(MDI)/BPDA/Desmodur | 20 | RTIL 3 | 1.62 × 10⁻⁴ | 0.0460 | — | — | — |
| (dry film) | Z4470 (n = 30) | | | S/cm | | | | |
| bn12.131.29P | DMBZ/(MDI)/BPDA/TAB | 20 | RTIL 2 | 1.64 × 10⁻³ | 0.0576 | 90 | 35.44 | 83.76 |
| | | | | S/cm | | | | |
| bn12.141.02P | ODA/(ED600)/BPDA/TAB | 20 | RTIL 2 | 1.57 × 10⁻³ | 0.0803 | 89 | — | — |
| | (n = 30) | | | S/cm | | | | |
| bn12.149.01P | ODA/(MDI)/BPDA/N3300A | 20 | RTIL 2 | 2.40 × 10⁻³ | 0.0636 | 89 | — | — |
| | | | | S/cm | | | | |
| bn12.149.02P | ODA/(MDI)/BPDA/N3300A | 20 | RTIL 2 | 1.75 × 10⁻³ | 0.0866 | 89 | — | — |
| | (n = 30) | | | S/cm | | | | |
| bn12.153.01P | ODA/(ED600)/BPDA/N3300A | 20 | RTIL 2 | 2.00 × 10⁻³ | 0.0908 | 93 | — | — |
| | (n = 30) | | | S/cm | | | | |
| bn12.153.02P | ODA/BPDA/N3300A | 20 | RTIL 2 | 1.76 × 10⁻³ | 0.0759 | 91 | 43.05 | — |
| | (n = 30) | | | S/cm | | | | |
| bn12.153.04P | ODA/BPDA/N3300A | 20 | RTIL 2 | 2.59 × 10⁻³ | 0.0978 | 94 | 14.58 | 20.67 |
| | (n = 30) | | | S/cm | | | | |
| | DMBZ/(MDI)/BPDA/TAB | 20 | RTIL 2 | 1.64 × 10⁻³ | 0.0678 | 90 | 35.44 | 83.76 |
| | (n = 30) | | | S/cm | | | | |
| bn12.177.01/bn12.131.29 | DMBZ/(MDI)/BPDA/TAB | 20 | RTIL 3 | 1.04 × 10⁻³ | 0.0551 | 90 | 35.44 | 83.76 |
| | (n = 30) | | | S/cm | | | | |
| bn12.177.02/bn12.141.02 | ODA/(ED600)/BPDA/TAB | 20 | RTIL 3 | 4.84 × 10⁻³ | 0.0680 | 89 | — | — |
| | (n = 30) | | | S/cm | | | | |
| bn12.177.03/bn12.149.01 | ODA/(MDI)/BPDA/N3300A | 20 | RTIL 3 | 1.68 × 10⁻³ | 0.0708 | 89 | — | — |
| | (n = 30) | | | S/cm | | | | |
| bn12.177.04/bn12.149.02 | ODA/(MDI)/BPDA/N3300A | 20 | RTIL 3 | 3.80 × 10⁻³ | 0.0686 | 89 | — | — |
| | (n = 30) | | | S/cm | | | | |
| bn12.177.05/bn12.153.01 | ODA/(ED600)/BPDA/N3300A | 20 | RTIL 3 | 4.56 × 10⁻³ | 0.0751 | 93 | — | — |
| | (n = 30) | | | S/cm | | | | |
| bn12.177.06/bn12.153.04 | ODA/BPDA/N3300A | 20 | RTIL 3 | 6.01 × 10⁻³ | 0.0835 | 94 | 14.58 | 20.67 |
| | (n = 30) | | | S/cm | | | | |
| bn12.177.07/bn12.155.02 | ODA/(ED600)/BPDA/TAB | 20 | RTIL 3 | 7.01 × 10⁻³ | 0.1216 | 92 | — | — |
| | (n = 30) | | | S/cm | | | | |
| bn12.177.08/bn12.155.04 | ODA/PMDA/TAB | 20 | RTIL 3 | 1.36 × 10⁻³ | 0.0480 | — | — | — |
| | (n = 30) | | | S/cm | | | | |
| bn12.177.09/bn12.155.09 | ODA/(ED600)/BPDA/TAB | 20 | RTIL 3 | 3.73 × 10⁻³ | 0.0468 | 94 | — | — |
| | (n = 30) | | | S/cm | | | | |
| bn12.177.10/bn12.155-14 | ODA/(ED600)/BPDA/TAB | 20 | RTIL 3 | 5.24 × 10⁻³ | 0.0552 | 89 | — | — |
| | (n = 30) | | | S/cm | | | | |
| bn13-49-01 | ODA/BPDA/N3300A | 20 | RTIL 3 | 5.71 × 10⁻³ | 0.0706 | 91 | 43.05 | — |
| (bn12.153.02) | (n = 30) | | | S/cm | | | | |
| bn13-49-02 | ODA/BPDA/N3300A | 10 | RTIL 3 | 5.57 × 10⁻³ | 0.0742 | 91 | 43.05 | — |
| (bn12.153.02) | (n = 30) | | | S/cm | | | | |
| bn13-49-03/bn13-45-01 | ODA/BPDA/TAB | 10 | RTIL 3 | 2.40 × 10⁻³ | 0.0076 | 88 | — | — |
| | (n = 30) | | | S/cm | | | | |
| bn13-53-01A/bn13-45.04 | ODA/BPDA/N3300A | 10 | RTIL 3 | 5.01 × 10⁻³ | 0.0070 | 87 | — | — |
| | (n = 40) | | | S/cm | | | | |
| bn 13-53-02A/bn13.45.15 | ODA/BPDA/TAB | 10 | RTIL 3 | 8.74 × 10⁻⁴ | 0.0066 | 85 | — | — |
| | (n = 40) | | | S/cm | | | | |
| bn13-53-03A | ODA/BPDA/N3300A | 10 | RTIL 3 | 1.69 × 10⁻³ | 0.0036 | 88 | — | — |
| (bn13.45.07/bn13.67-01.A)) | (n = 60) | | | S/cm | | | | |
| | ODA/BPDA/N3300A | 10 | RTIL 3 | 3.23 × 10⁻³ | 0.0158 | — | — | — |
| | (n = 60) | | | S/cm | | | | |
| bn13.53.04B/bn13-45.04 | ODA/BPDA/N3300A | 10 | RTIL 4 | 3.84 × 10⁻³ | 0.0056 | 87 | — | — |
| | (n = 40) | | | S/cm | | | | |
| bn13.53-05B/bn13.45.05 | ODA/BPDA/TAB | 10 | RTIL 4 | 1.67 × 10⁻⁴ | 0.0057 | 85 | — | — |
| | (n = 40) | | | S/cm | | | | |
| bn13-53-06B | ODA/BPDA/N3300A | 10 | RTIL 4 | NA | too thin, | — | — | — |
| (bn13.45.07/bn13-67.02.B2) | (n = 60) | | | | broken | | | |
| bn13-67-03.C1 | ODA/BPDA/N3300A | 10 | RTIL 5 | — | — | — | — | — |
| (bn12.153.02) | (n = 30) | | | | | | | |
| bn13-67-03.C2 | ODA/BPDA/N3300A | 10 | RTIL 5 | 7.22 × 10⁻³ | 0.0040 | 88 | — | — |
| (bn13.45.07) | (n = 60) | | | S/cm | | | | |
| bn13-67-04.D1 | ODA/BPDA/N3300A | 10 | RTIL 6 | 4.19 × 10⁻³ | 0.0774 | 88 | — | — |
| (bn12.153.02) | (n = 30) | | | S/cm | | | | |
| bn13-67-04.D2 | ODA/BPDA/N3300A | 10 | RTIL 6 | — | — | — | — | — |
| (bn13.45.07) | (n = 60) | | | | | | | |
| bn13-67-05.E1 | ODA/BPDA/N3300A | 10 | RTIL 7 | 1.49 × 10⁻³ | 0.0738 | 91 | — | — |
| (bn12.153.02) | (n = 30) | | | S/cm | | | | |
| bn13-67-05.E2 | ODA/BPDA/N3300A | 10 | RTIL 7 | — | — | — | — | — |
| (bn13.45.07) | (n = 60) | | | | | | | |
| bn13-67-06.F1 | ODA/BPDA/N3300A | 10 | RTIL 8 | 3.62 × 10⁻⁴ | 0.0710 | 91 | — | — |
| (bn12.153.02) | (n = 30) | | | S/cm | | | | |
| bn13-67-06.F2 | ODA/BPDA/N3300A | 10 | RTIL 8 | — | — | — | — | — |
| (bn13.45.07) | (n = 60) | | | | | | | |
| bn13-67-07.G1 | ODA/BPDA/N3300A | 10 | RTIL 9 | 2.37 × 10⁻³ | 0.0702 | 91 | — | — |
| (bn12.153.02) | (n = 30) | | | S/cm | | | | |
| bn13-67-07.G2 | ODA/BPDA/N3300A | 10 | RTIL 9 | — | — | — | — | — |
| (bn13.45.07) | (n = 60) | | | | | | | |
| bn13-67-08.H1 | ODA/BPDA/N3300A | 10 | RTIL 10 | 3.58 × 10⁻³ | 0.0778 | 91 | — | — |
| (bn12.153.02) | (n = 30) | | | S/cm | | | | |
| bn13-67-08.H2 | ODA/BPDA/N3300A | 10 | RTIL 10 | — | — | — | — | — |
| (bn13.45.07) | (n = 60) | | | | | | | |
| bn13-67-09.I1 | ODA/BPDA/N3300A | 10 | RTIL 11 | 3.91 × 10⁻³ | 0.0834 | 91 | — | — |
| (bn12.153.02) | (n = 30) | | | S/cm | | | | |
| bn13-67-09.I2 | ODA/BPDA/N3300A | 10 | RTIL - 11 | — | — | — | — | — |
| (bn13.45.07) | (n = 60) | | | | | | | |
| bn13-67-10.J2 | ODA/BPDA/N3300A | 10 | RTIL 12 | 3.35 × 10⁻⁴ | 0.0070 | 88 | — | — |
| (bn13.45.07) | (n = 60) | | | S/cm | | | | |

*Additional details for Table 1, regarding molar ratio of ED600 to diamine, “weight % polymer”, tensile modulus (Mpa) (film), film thickness, n-values, and chemical formula key, are provided below. Room temperature ionic liquids are listed in Table 3.

TABLE 2
Formulations and properties of polyimide-network battery-separator compositions and polyimide-
urea-network battery-separator compositions, in which salt corresponds to Li TFSI.*

| Chemical Formula: | | | | | | | | |
|---|---|---|---|---|---|---|---|---|
| Diamine/(Diisocyanate or | | | | | | | | |
| Additional Diamine)/ | | | Salt | | | | | |
| Dianhydride/ | | Weight % | (g/100 g | | Ionic | Film | % | Viscosity |
| Cross-Linker | n-Value | Polymer | RTIL) | RTIL | Conductivity | thickness, cm | Porosity | (cP) |
| DMBZ/(ED600)/BPDA/N3300A | 30 | 10 | 10 | RTIL 1 | 5.59 × 10⁻⁴ S/cm | 0.0213 | — | 58.7 |
| DMBZ/BPDA/TAB | 30 | 10 | 10 | RTIL 1 | 1.22 × 10⁻³ S/cm | 0.0586 | 90 | 58.7 |
| DMBZ/BTDA/TAB | 30 | 8.5 | 10 | RTIL 1 | 9.47 × 10⁻⁴ S/cm | 0.0646 | 88 | 58.7 |
| DMBZ/(MDI)/BTDA/TAB | 30 | 10 | 20 | RTIL 1 | 7.33 × 10⁻⁴ S/cm | 0.0831 | 88 | 58.7 |
| DMBZ/(MDI)/BPDA/TAB | 30 | 8.5 | 20 | RTIL 1 | 1.20 × 10⁻³ S/cm | 0.0780 | 90 | 58.7 |
| DMBZ/BTDA/TAB | 30 | 10 | 20 | RTIL 1 | 7.35 × 10⁻⁴ S/cm | 0.0856 | 85 | 58.7 |
| BAPP/(MDI)/BTDA/TAB | 30 | 10 | 10 | RTIL 1 | 1.24 × 10⁻³ S/cm | 0.0327 | 88 | 58.7 |
| BAPP/(MDI)/BTDA/TAB | 30 | 10 | 10 | RTIL 1 | 7.22 × 10⁻⁴ S/cm | 0.0222 | 88 | 58.7 |
| BAPP/BTDA/TAB | 30 | 10 | 20 | RTIL 1 | 1.10 × 10⁻³ S/cm | 0.0991 | 87 | 58.7 |
| ODA/(ED600)/BPDA/N3300A | 30 | 10 | 10 | RTIL 1 | 1.67 × 10⁻³ S/cm | 0.0320 | 90 | 58.7 |
| ODA/(ED600)/BPDA/TAB | 30 | 10 | 20 | RTIL 1 | 9.64 × 10⁻⁴ S/cm | 0.0678 | — | 58.7 |
| ODA/(MDI)/BPDA/N3300A | 30 | 8.5 | 20 | RTIL 1 | 1.25 × 10⁻³ S/cm | 0.0650 | 89 | 58.7 |
| DMBZ/(MDI)/BPDA/TAB | 30 | 8.5 | 20 | RTIL 2 | 1.64 × 10⁻³ S/cm | 0.0576 | 90 | 72.1 |
| ODA/(ED600)/BPDA/TAB | 30 | 10 | 20 | RTIL 2 | 1.57 × 10⁻³ S/cm | 0.0803 | — | 72.1 |
| ODA/(ED600)/BPDA/N3300A | 30 | 10 | 20 | RTIL 2 | 2.00 × 10⁻³ S/cm | 0.0908 | 93 | 72.1 |
| ODA/(MDI)/BPDA/N3300A | 30 | 8.5 | 20 | RTIL 2 | 2.40 × 10⁻³ S/cm | 0.0636 | 89 | 72.1 |
| ODA/(MDI)/BPDA/N3300A | 30 | 10 | 20 | RTIL 2 | 1.75 × 10⁻³ S/cm | 0.0866 | 89 | 72.1 |
| ODA/BPDA/N3300A | 30 | 10 | 20 | RTIL 2 | 1.76 × 10⁻³ S/cm | 0.0759 | 91 | 72.1 |
| ODA/BPDA/N3300A | 30 | 8 | 20 | RTIL 2 | 2.59 × 10⁻³ S/cm | 0.0978 | 94 | 72.1 |
| DMBZ/(MDI)/BPDA/TAB | 30 | 8.5 | 20 | RTIL 3 | 1.04 × 10⁻³ S/cm | 0.0551 | 90 | 39.4 |
| DMBZ/(MDI)/BPDA/Desmodur Z4470 | 30 | 7 | 20 | RTIL 1 | 9.36 × 10⁻⁴ S/cm | 0.0524 | — | 39.4 |
| DMBZ/(MDI)/BPDA/Desmodur Z4470 | 30 | 10 | 20 | RTIL 1 | 1.62 × 10⁻⁴ S/cm | 0.0460 | — | 39.4 |
| ODA/(ED600)/BPDA/TAB | 30 | 10 | 20 | RTIL 3 | 4.84 × 10⁻³ S/cm | 0.0680 | — | 39.4 |
| ODA/(ED600)/BPDA/N3300A | 30 | 10 | 20 | RTIL 3 | 4.56 × 10⁻³ S/cm | 0.0751 | 93 | 39.4 |
| ODA/(ED600)/BPDA/TAB | 30 | 10 | 20 | RTIL 3 | 7.01 × 10⁻³ S/cm | 0.1216 | 92 | 39.4 |
| ODA/(ED600)/BPDA/TAB | 30 | 9 | 20 | RTIL 3 | 3.73 × 10⁻³ S/cm | 0.0468 | — | 39.4 |
| ODA/(ED600)/BPDA/TAB | 30 | 10 | 20 | RTIL 3 | 5.24 × 10⁻³ S/cm | 0.0552 | — | 39.4 |
| ODA/(MDI)/BPDA/N3300A | 30 | 8.5 | 20 | RTIL 3 | 1.68 × 10⁻³ S/cm | 0.0708 | 89 | 39.4 |
| ODA/(MDI)/BPDA/N3300A | 30 | 10 | 20 | RTIL 3 | 3.80 × 10⁻³ S/cm | 0.0686 | 89 | 39.4 |
| ODA/BPDA/N3300A | 30 | 8 | 20 | RTIL 3 | 6.01 × 10⁻³ S/cm | 0.0835 | 94 | 39.4 |
| ODA/PMDA/TAB | 30 | 8 | 20 | RTIL 3 | 1.36 × 10⁻³ S/cm | 0.0480 | — | 39.4 |
| ODA/BPDA/N3300A | 30 | 10 | 20 | RTIL 3 | 5.71 × 10⁻³ S/cm | 0.0706 | 91 | 39.4 |
| ODA/BPDA/N3300A | 30 | 10 | 10 | RTIL 3 | 5.57 × 10⁻³ S/cm | 0.0742 | 91 | 39.4 |
| ODA/BPDA/TAB | 30 | 9 | 10 | RTIL 3 | 2.40 × 10⁻³ S/cm | 0.0076 | — | 39.4 |
| ODA/BPDA/N3300A | 40 | 10 | 10 | RTIL 3 | 5.01 × 10⁻³ S/cm | 0.0070 | — | 39.4 |
| ODA/BPDA/TAB | 40 | 10 | 10 | RTIL 3 | 8.74 × 10⁻⁴ S/cm | 0.0066 | — | 39.4 |
| ODA/BPDA/N3300A | 60 | 10 | 10 | RTIL 3 | 1.69 × 10⁻³ S/cm | 0.0036 | — | 39.4 |
| DMBZ/(MDI)/BPDA/TAB | 30 | 8.5 | 20 | RTIL 3 | 1.04 × 10⁻³ S/cm | 0.0551 | 90 | 39.4 |
| ODA/BPDA/TAB | 40 | 10 | 10 | RTIL 4 | 1.67 × 10⁻⁴ S/cm | 0.0057 | — | — |
| ODA/BPDA/N3300A | 40 | 10 | 10 | RTIL 4 | 3.84 × 10⁻³ S/cm | 0.0056 | — | — |
| ODA/BPDA/N3300A | 60 | 10 | 10 | RTIL 5 | 7.22 × 10⁻³ S/cm | 0.0040 | — | 33.8 |
| ODA/BPDA/N3300A | 30 | 10 | 10 | RTIL 6 | 4.19 × 10⁻³ S/cm | 0.0774 | — | 27.9 |
| ODA/BPDA/N3300A | 30 | 10 | 10 | RTIL 7 | 1.49 × 10⁻³ S/cm | 0.0738 | — | 43.8 |
| ODA/BPDA/N3300A | 30 | 10 | 10 | RTIL 8 | 3.62 × 10⁻⁴ S/cm | 0.0710 | — | 99.5 |
| ODA/BPDA/N3300A | 30 | 10 | 10 | RTIL 9 | 2.37 × 10⁻³ S/cm | 0.0702 | — | 46.9 |
| ODA/BPDA/N3300A | 30 | 10 | 10 | RTIL 10 | 3.58 × 10⁻³ S/cm | 0.0778 | — | 37.7 |
| ODA/BPDA/N3300A | 30 | 10 | 10 | RTIL 11 | 3.91 × 10⁻³ S/cm | 0.0834 | — | 35.0 |
| ODA/BPDA/N3300A | 60 | 10 | 10 | RTIL 12 | 3.35 × 10⁻⁴ S/cm | 0.0070 | — | — |

*The same abbreviations are used for chemical formulations and room temperature ionic liquids in Table 2 as for Table 1.

TABLE 3
Room temperature ionic liquids

| Number | Room Temperature Ionic Liquid | Viscosity |
|---|---|---|
| RTIL 1 | 1-methyl-1-propylpyrrolidinium | 58.7 |
| | bis(trifluoromethylsulfonyl)imide | |
| RTIL 2 | 1-butyl-1-methylpyrrolidinium | 72.1 |
| | bis(trifluoromethylsulfonyl)imide | |
| RTIL 3 | 1-ethyl-3-methylimidazolium | 39.4 |
| | bis(trifluoromethylsulfonyl)imide | |
| RTIL 4 | 1-ethyl-3-methylimidazolium triflate | — |
| RTIL 5 | 1-ethyl-3-methylimidazolium | 33.8 |
| | tetrafluoroborate | |
| RTIL 6 | 1,3-diethylimidazolium | 27.9 |
| | bis(trifluoromethylsulfonyl)imide | |
| RTIL 7 | 1-methyl-3-propylimidazolium | 43.8 |
| | bis(trifluoromethylsulfonyl)imide | |
| RTIL 8 | butyltrimethylammonium | 99.5 |
| | bis(trifluoromethylsulfonyl)imide | |
| RTIL 9 | 1-(2-methoxyethyl)-3- | 46.9 |
| | methylimidazolium | |
| | bis(trifluoromethylsulfonyl)imide | |
| RTIL 10 | Diethylmethylammonium | 37.7 |
| | trifluoromethanesulfonate | |
| RTIL 11 | 1-allyl-3-methylimidazolium | 35.0 |
| | bis(trifluoromethylsulfonyl)imide | |
| RTIL 12 | N,N-diethyl-N-methyl- | — |
| | N-(2-methoxyethyl)ammonium | |
| | bis(trifluoromethylsulfonyl)imide | |

TABLE 4
Lithium salts suitable for use with lithium-based batteries.

| Lithium Salt | Abbreviation |
|---|---|
| Lithium hexafluoroarsenate | Li AsF6− |
| Lithium hexafluorophosphate | Li PF6− |
| Lithium nitrate | Li NO3− |
| Lithium perchlorate | Li ClO4− |
| Lithium tetrafluoroborate | Li BF4− |
| Lithium tris(pentafluoroethyl)trifluorophosphate | Li FAP |
| Lithium trifluoromethanesulfonate | Li Triflate or |
| | Li CF3SO3− |
| Lithium bis(fluorosulfonyl)imide | Li FSI |
| Lithium cyclo-difluoromethane-1,1- | Li DMSI |
| bis(sulfonyl)imide | |
| Lithium cyclo-hexafluoropropane-1,1- | Li HPSI |
| bis(sulfonyl)imide | |
| Lithium bis(trifluoromethanesulfonyl)imide | Li TFSI |
| Lithium bis(perfluoroethanesulfonyl)imide | Li BETI |
| Lithium bis(oxalate)borate | Li BOB |
| Lithium difluoro(oxalato)borate | Li DFOB |
| Lithium bis(fluoromalonato)borate | Li BFMB |
| Lithium tetracyanoborate | Li Bison |
| Lithium dicyanotriazolate | Li DCTA |
| Lithium dicyano-trifluoromethyl-imidazole | Li TDI |
| Lithium dicyano-pentafluoroethyl-imidazole | Li PDI |

Additional Details for Table 1 are as follows:

Molar Ratio of ED600 to Diamine
Molar ratio of ED600 to diamine=0.15 for samples bn12.153.01P, bn12.177.10/bn12.155-14, and bn12.177.05/bn12.153.01.
Molar ratio of ED600 to diamine=0.3 for samples bn12.121.01, bn12.177.07/bn12.155.02, and bn12.125.01 (dry film).
Molar ratio of ED600 to diamine=0.5 for samples bn12.141.02, bn12.141.02 (dried in air), bn12.141.02P, bn12.177.02/bn12.141.02.
Molar ratio of ED600 to diamine=0.6 for sample bn12.177.09/bn12.155.09.

“Weight % Polymer”
“Weight % polymer” corresponds to sum of the weights of monomers (diamine(s), dianhydride, cross-linking agent, and diisocyanate if present) dissolved into solution in which the corresponding polyimide network or polyimide-urea network will be synthesized, minus the weights of corresponding condensation products (usually water, but when 1,3,5-benzenetricarbonyl trichloride is used, water and HCl), expressed as weight percent of the solution.
“Weight % polymer”=7 for sample bn12.177.11 (dry film).
“Weight % polymer”=8 for samples bn12.153.04P, bn12.177.06/bn12.153.04, and bn12.177.08/bn12.155.04.
“Weight % polymer”=8.5 for samples bn12.131.04, bn12.131.29, bn12.149.01, bn12.131.29 (dried in air), bn12.149.01 (dried in air), bn12.131.29P, bn12.149.01P, bn12.177.01/bn12.131.29, and bn12.177.03/bn12.149.01.
“Weight % polymer”=9 for samples bn12.177.09/bn12.155.09 and bn13-49-03/bn13-45-01.
“Weight % polymer”=10 for remaining samples.

Tensile Modulus (Mpa) (Film)
Sample bn12.131.29 exhibited a tensile modulus (Mpa) (film)=68.373.

Film Thickness
Samples corresponding to thin films include bn13-53-03A (bn13.45.07/bn13.67-01.A)), bn13-53-06B (bn13.45.07/bn13-67.02.B2), bn13-67-03.C2 (bn13.45.07), bn13-67-04.D2 (bn13.45.07), bn13-67-05.E2 (bn13.45.07), bn13-67-06.F2 (bn13.45.07), bn13-67-07.G2 (bn13.45.07), bn13-67-08.H2 (bn13.45.07), bn13-67-09.12 (bn13.45.07), and bn13-67-10.J2 (bn13.45.07).
Samples corresponding to thick films include bn12.153.02P, bn13-49-01 (bn12.153.02), bn13-49-02 (bn12.153.02), bn13-67-03.C1 (bn12.153.02), bn13-67-04.D1 (bn12.153.02), bn13-67-05.E1 (bn12.153.02), bn13-67-06.F1 (bn12.153.02), bn13-67-07.G1 (bn12.153.02), bn13-67-08.H1 (bn12.153.02), and bn13-67-09.11 (bn12.153.02).
Samples characterized as “fragile/thick” include bn12.177.07/bn12.155.02.
Samples characterized as “too thin-broken” include bn13-53-03A (bn13.45.07/bn13.67-01.A)), bn13-53-06B (bn13.45.07/bn13-67.02.132), and bn13-67-03.C2 (bn13.45.07).

n-Values
For polyimide networks, n corresponds to number of repeating units of dianhydride and diamine present in corresponding polyamic acid oligomer.
For polyimide urea networks, n corresponds to number of repeating units of dianhydride and diamine present in corresponding subunit of comprising two polyamic acid oligomers in direct connection via urea linkage.

Chemical Formula Key:
DMBZ=2,2′-dimethylbenzidine
BAPP=2,2-bis [4-(4-aminophenoxy)phenyl] propane
ODA=4,4′-oxydianiline
ED600=O,O′-bis(2-aminopropyl) polypropylene glycol-block-polyethylene glycol-block-polypropylene glycol
MDI=methylene diphenyl diisocyanate
BPDA=3,3′,4,4′-biphenyltetracarboxylic dianhydride
BTDA=benzophenone-3,3′,4,4′-tetracarboxylic dianhydride
PMDA=pyromellitic dianhydride
N3300A=polyfunctional aliphatic isocyanate resin based on hexamethylene diisocyanate (HDI)
TAB=1,3,5-triaminophenoxybenzene
Desmodur Z4470=aliphatic polyisocyanate (IPDI trimer)

Additional Details
Sample bn12.125.01 (dry film) corresponds to a polyimide aerogel film that was imbibed in 1 L of room temperature ionic liquid.
Samples bn12.123.02 (dry film), bn12.177.11 (dry film), and bn12-177.12 (dry film) correspond to polyimide-urea aerogel films that were imbibed in 1 L of room temperature ionic liquid.
The following samples were retested after being dried in air for about 2 weeks: bn12.131.34 (dried in air), bn12.131.19 (dried in air), bn12.141.02 (dried in air), bn12.131.11 (dried in air), bn12.131.29 (dried in air). The corresponding original samples were bn12.131.34/CD01-19-02, bn12.131.19, bn12.141.02, bn12.131.11, bn12.131.29, respectively. The sample bn12.149.01 (dried in air) also was so retested.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A polyimide-network battery-separator composition comprising:
(a) a porous cross-linked polyimide network comprising a polyamic acid oligomer, wherein the polyamic acid oligomer (i) comprises a repeating unit of a dianhydride and a diamine and terminal functional groups, (ii) has an average degree of polymerization of 10 to 70, (iii) has been cross-linked via a cross-linking agent, comprising three or more cross-linking groups, at a balanced stoichiometry of the cross-linking groups to the terminal functional groups, and (iv) has been chemically imidized to yield the porous cross-linked polyimide network; and
(b) an electrolyte composition comprising (i) a room temperature ionic liquid and (ii) a lithium ion, wherein the electrolyte composition is interfused within the porous cross-linked polyimide network.

2. The polyimide-network battery-separator composition of claim 1, wherein the dianhydride comprises one or more of biphenyl-3,3′,4,4′-tetracarboxylic dianhydride, benzophenone-3,3′,4,4′-tetracarboxylic dianhydride, pyromellitic dianhydride, or 2,2′-bis(3,4′-dicarboxyphenyl)hexafluoropropane dianhydride.

3. The polyimide-network battery-separator composition of claim 1, wherein the diamine comprises one or more of 2,2′-dimethylbenzidine, 2,2′-bis[4-(4-am inophenoxy)phenyl]propane, 4,4′-oxydianiline, 3,4′-oxydianiline, p-phenylene diamine, bisaniline-p-xylidene, 4,4′-bis(4-am inophenoxy)biphenyl, 3,3′-bis(4-am inophenoxy)biphenyl, 4,4′-(1,4-phenylenediisopropylidene)bisaniline, 4,4′-(1,3-phenylenediisopropylidene)bisaniline, or O,O′-bis(2-aminopropyl) polypropylene glycol-block-polyethylene glycol-block-polypropylene glycol.

4. The polyimide-network battery-separator composition of claim 1, wherein the terminal functional groups comprise (i) terminal anhydride groups, such that the polyamic acid oligomer comprises an anhydride end-capped polyamic acid oligomer, (ii) terminal amine groups, such that the polyamic acid oligomer comprises an amine end-capped polyamic acid oligomer, or (iii) terminal anhydride groups and terminal amine groups.

5. The polyimide-network battery-separator composition of claim 1, wherein the three or more cross-linking groups comprise one or more of isocyanate groups, amine groups, or acid chloride groups.

6. The polyimide-network battery-separator composition of claim 5, wherein the three or more cross-linking groups comprise isocyanate groups, and the cross-linking agent comprises one or more of a triisocyanate, trifunctional aliphatic isocyanate N3300A, or aliphatic polyisocyanate Desmodur Z4470.

7. The polyimide-network battery-separator composition of claim 5, wherein the three or more cross-linking groups comprise amine groups, and the cross-linking agent comprises one or more of a triamine, an aliphatic amine comprising three or more amines, an aliphatic triamine, an aromatic amine comprising three or more amine groups, an aromatic triamine, 1,3,5-tri(aminophenoxy)benzene, a silica cage structure decorated with three or more amines, octa(aminophenyl)silsesquioxane, octa(aminophenyl)silsesquioxane as a mixture of isomers having the ratio meta:ortho:para of 60:30:10, or para-octa(aminophenyl)silsesquioxane.

8. The polyimide-network battery-separator composition of claim 5, wherein the three or more cross-linking groups comprise acid chloride groups, and the cross-linking agent comprises one or more of a triacid chloride or 1,3,5-benzenetricarbonyl trichloride.

9. The polyimide-network battery-separator composition of claim 1, wherein the polyamic acid oligomer has been chemically imidized to completion.

10. The polyimide-network battery-separator composition of claim 1, wherein the room temperature ionic liquid comprises one or more of 1-methyl-1-propylpyrrolidinium bis(trifluoromethylsulfonayl)imide, 1-butyl-1-methylpyrrolidinium bis(trifluoromethylsulfonayl)imide, 1-ethyl-3-methylimidazolium bis(trifluoromethylsulfonyl)imide, 1-ethyl-3-methylimidazolium triflate, 1-ethyl-3-methylimidazolium tetraborate, 1,3-diethylimidazolium bis(trifluoromethylsulfonyl)imide, 1-methyl-3-propylimidazolium bis(trifluoromethylsulfonyl)imide, butyltrimethylammonium bis(trifluoromethylsulfonayl)imide, 1-(2-methoxyethyl)-3-methylimidazolium bis(trifluoromethylsulfonyl)imide, diethylmethylammonium trifluoromethanesulfonate, 1-allyl-3-methylimidazolium bis(trifluoromethylsulfonyl)imide, or N,N-diethyl-N-methyl-N-(2-methoxyethyl) ammonium bis(trifluoromethylsulfonayl)imide.

11. The polyimide-network battery-separator composition of claim 1, wherein the lithium ion was obtained by dissolving, in the room temperature ionic liquid, one or more of lithium hexafluoroarsenate, lithium hexafluorophosphate, lithium nitrate, lithium perchlorate, lithium tetrafluoroborate, lithium tris(pentafluoroethyl)trifluorophosphate, lithium trifluoromethanesulfonate, lithium bis(fluorosulfonyl)imide, lithium cyclo-difluoromethane-1,1-bis(sulfonyl)imide, lithium cyclo-hexafluoropropane-1,1-bis(sulfonyl)imide, lithium bis(trifluoromethanesulfonyl)imide, lithium bis(perfluoroethanesulfonyl)imide, lithium bis(oxalate)borate, lithium difluoro(oxalato)borate, lithium bis(fluoromalonato)borate, lithium tetracyanoborate, lithium dicyanotriazolate, lithium dicyano-trifluoromethyl-imidazole, or, lithium dicyano-pentafluoroethyl-imidazole.

12. The polyimide-network battery-separator composition of claim 1, wherein the porous cross-linked polyimide network has a porosity of 80 to 95%.

13. The polyimide-network battery-separator composition of claim 1, wherein the polyimide-network battery-separator composition is in the form of a film and has a film thickness of 0.0050 to 0.1000 cm.

14. The polyimide-network battery-separator composition of claim 1, wherein the polyimide-network battery-separator composition has an ionic conductivity, across the porous cross-linked polyimide network, of 1.0×10⁻⁴ to 8.0×10⁻³ S/cm at 25° C.

15. A lithium-based voltaic cell comprising a cathode, an anode, and the polyimide-network battery separator composition of claim 1.

16. The lithium-based voltaic cell of claim 15, wherein (i) the porous cross-linked polyimide network has a porosity of 80 to 95%, (ii) the polyimide-network battery-separator composition is in the form of a film and has a film thickness of 0.0050 to 0.1000 cm, and (iii) the polyimide-network battery-separator composition has an ionic conductivity, across the porous cross-linked polyimide network, of 1.0×10⁻⁴ to 8.0×10⁻³ S/cm.

17. A polyimide-urea-network battery-separator composition comprising:
(a) a porous cross-linked polyimide-urea network comprising a subunit comprising two polyamic acid oligomers in direct connection via a urea linkage, wherein:
(i) the polyamic acid oligomers (a) each comprise a repeating unit of a dianhydride and a diamine and a terminal functional group and (b) are formulated with 2 to 20 of the repeating units;
(ii) the subunit was formed by reaction of the diamine and a diisocyanate to form a diamine-urea linkage-diamine group, followed by reaction of the diamine-urea linkage-diamine group with the dianhydride and the diamine to form the subunit;
(iii) the subunit has been cross-linked via a cross-linking agent, comprising three or more cross-linking groups, at a balanced stoichiometry of the cross-linking groups to the terminal functional groups; and
(iv) the subunit has been chemically imidized to yield the porous cross-linked polyimide-urea network; and
(b) an electrolyte composition comprising (i) a room temperature ionic liquid and (ii) a lithium ion, wherein the electrolyte composition is interfused within the porous cross-linked polyimide network.

18. The polyimide-urea-network battery-separator composition of claim 17, wherein the dianhydride comprises one or more of biphenyl-3,3′,4,4′-tetracarboxylic dianhydride, benzophenone-3,3′,4,4′-tetracarboxylic dianhydride, pyromellitic dianhydride, or 2,2′-bis(3,4′-dicarboxyphenyl)hexafluoropropane dianhydride.

19. The polyimide-urea-network battery-separator composition of claim 17, wherein the diamine comprises one or more of 2,2′-dimethylbenzidine, 2,2′-bis[4-(4-am inophenoxy)phenyl]propane, 4,4′-oxydianiline, 3,4′-oxydianiline, p-phenylene diamine, bisaniline-p-xylidene, 4,4′-bis(4-am inophenoxy)biphenyl, 3,3′-bis(4-aminophenoxy)biphenyl, 4,4′-(1,4-phenylenediisopropylidene)bisaniline, 4,4′-(1,3-phenylenediisopropylidene)bisaniline, or O,O′-bis(2-aminopropyl) polypropylene glycol-block-polyethylene glycol-block-polypropylene glycol.

20. The polyimide-urea-network battery-separator composition of claim 17, wherein the diisocyanate comprises 4,4′-methylene-bis-diphenyldiisocyanate.

21. The polyimide-urea-network battery-separator composition of claim 17, wherein the three or more cross-linking groups comprise one or more of isocyanate groups, amine groups, or acid chloride groups.

22. A lithium-based voltaic cell comprising a cathode, an anode, and the polyimide-urea-network battery separator composition of claim 17.
